(19) United States
(12) Patent Application Publication
(10) Pub. No.: US 2012/0194452 A1
(43) Pub. Date: Aug. 2, 2012

(54) METHODS OF DETECTING MULTI-TOUCH AND PERFORMING NEAR-TOUCH SEPARATION IN A TOUCH PANEL

(75) Inventors: Hwa-Hyun CHO, Seoul (KR); Yoon-Kyung CHOI, Yongin-si (KR)

(73) Assignee: SAMSUNG ELECTRONICS CO., LTD., Suwon-si (KR)

(21) Appl. No.: 13/299,557

(22) Filed: Nov. 18, 2011

(30) Foreign Application Priority Data
Feb. 1, 2011 (KR) 10-2011-0010257

(51) Int. Cl. G06F 3/041

(52) U.S. Cl. 345/173

(57) ABSTRACT

A method of detecting multi-touch in a touch panel a plurality of panel points for sensing respective input touch levels is provided. The method includes determining touch levels by adaptively removing noise touch levels among the input touch levels based on a distribution of the input touch levels, and determining a touch point among the panel points having the valid touch levels by performing near-touch separation based on a two-dimensional pattern of the valid touch levels.

### CROSS-REFERENCE TO RELATED APPLICATIONS

This application claims priority under 35 U.S.C. §119 to Korean Patent Application No. 10-2011-0010257, filed on Feb. 1, 2011 in the Korean Intellectual Property Office (KIPO), the contents of which are incorporated herein in its entirety by reference.

### BACKGROUND

1. Technical Field

Apparatuses and methods consistent with exemplary embodiments relate generally to a touch panel, and more particularly to detecting multi-touch and methods of performing near-touch separation in a touch panel, and operating a touch screen including a touch panel.

2. Description of the Related Art

Touch panels and touch screens are widely used in electronic devices to detect an input action or an event by a user. The user may use fingers or stylus pens to touch the surface of the touch screen so that a desired function may be performed in the electronic device adopting the touch screen as one of the input means.

Uses of the touch screen are expanding to various devices, particularly to mobile devices pursuing miniaturization, and the touch screen is replacing the input means such as a keyboard, a mouse, etc. As uses are expanded and performance is improved, advanced functions such as multi-touch, in which r multiple positions in the touch screen are touched substantially at the same time, are being investigated.

### SUMMARY

One or more exemplary embodiments provide methods of detecting multi-touch and methods of performing near-touch separation in a touch panel.

One or more exemplary embodiments also provide a touch screen device and related methods.

According to an aspect of an exemplary embodiment, there is provided a method of detecting multi-touch in a touch panel, the touch panel having a plurality of panel points for sensing respective input touch levels, the method including determining valid touch levels by adaptively removing noise touch levels among the input touch levels depending on a distribution of the input touch levels; and determining one or more touch points among the panel points having the valid touch levels by performing near-touch separation based on a two-dimensional pattern of the valid touch levels.

The valid touch levels may be determined by adaptively determining a noise reference level depending on the distribution of the input touch levels, removing, as the noise touch levels, the input touch levels that is less than the noise reference level, and retaining, as the valid touch levels, the input touch levels that are equal to or greater than the noise reference level.

The noise reference level may be determined by calculating a histogram that represents respective numbers of the panel points having the respective input touch levels, calculating a noise distribution of the input touch levels that are less than a threshold touch level and a touch distribution of the input touch levels that are equal to or greater than the threshold touch level, with respect to a plurality of threshold touch levels, and determining the noise reference level based on the histogram, the noise distribution and the touch distribution.

The noise reference level may be set to the threshold touch level that gives a maximum value of VBC(t)=WN(t)*WT(t)*[MN(t)−MT(t)]2, where t denotes the threshold touch level, WN(t) denotes a noise histogram weight value of the input touch levels that are less than the threshold touch level, MN(t) denotes a noise mean value of the input touch levels that are less than the threshold touch level, WT(t) denotes a touch histogram weight value of the input touch levels that area equal to or greater than the threshold touch level, and MT(t) denotes a touch mean value of the input touch levels that area equal to or greater than the threshold touch level.

Alternatively, the noise reference level may be set to the threshold touch level that gives a minimum value of VWC(t)=WN(t)*VN(t)+WT(t)*VT(t), where t denotes the threshold touch level, WN(t) denotes a noise histogram weight value of the input touch levels that are less than the threshold touch level, VN(t) denotes a noise variance value of the input touch levels that are less than the threshold touch level, WT(t) denotes a touch histogram weight value of the input touch levels that are equal to or greater than the threshold touch level, and VT(t) denotes a touch variance value of the input touch levels that are equal to or greater than the threshold touch level.

The one or more touch points may be determined by determining one or more touch groups, each touch group corresponding to the panel points that have the valid touch levels and are adjacent from each other in the touch panel, determining a pattern of each touch group among a row-directional pattern and a column-directional pattern, and separating the touch points in each touch group based on the pattern of each touch group to provide coordinates of the touch points.

The touch groups may be determined by generating a binary map by assigning a first value to the panel points having the valid touch levels and by assigning a second value to the panel points having the noise touch levels, and scanning the binary map to determine the touch groups.

The binary map may be scanned by setting a kernel including kernel points adjacent to a source point, and detecting a new touch group when the source point has the first value and all of the kernel points have the second value.

The kernel points may be set to (x−1, y−1), (x, y−1), (x+1, y−1) and (x−1, y) with respect to the source point (x, y), where x is a column coordinate and y is a row coordinate, and the binary map may be scanned for all of the source points starting from the source point (0, 0) such that the column coordinate x is increased first and the row coordinate y is increased when one row is scanned.

The pattern of each touch group may be determined by determining a column-directional edge value corresponding to a number of peak maximum values of row-directional sums, each row-directional sum being obtained by adding the valid touch levels of the panel points in each row of each touch group, determining a row-directional edge value corresponding to a number of peak maximum values of column-directional sums, each column-directional sum being obtained by adding the valid touch levels of the panel points in each column of each touch group, and comparing the column-directional edge value and the row-directional edge value to determine the pattern of each touch group.

Alternatively, the pattern of each touch group may be determined by comparing a row-directional length and a column-directional length of each touch group to determine the pattern of each touch group.

An unintended touch may be detected when at least one of a row-directional length and a column-directional length of each touch group is greater than a reference length.

The touch points in each touch group may be separated by obtaining candidate coordinates of the panel points having maximum valid touch levels in each row or in each column of each touch group depending on each pattern of each touch group, and comparing the maximum valid touch levels to determine the coordinates of the touch points among the candidate coordinates.

According to one or more exemplary embodiments, there is provided a method of operating a touch screen including a touch panel and a display panel, the touch panel having a plurality of panel points for sensing respective input touch levels, the method comprising determining valid touch levels by adaptively removing noise touch levels among the input touch levels depending on a distribution of the input touch levels; determining one or more touch points among the panel points by performing near-touch separation based on a two-dimensional pattern of the valid touch levels; and extracting mapped coordinates of touch pixels in the display panel, the touch pixels in the display panel corresponding to the touch points in the touch panel.

The mapped coordinates of the touch pixels may be extracted by setting a mask including a portion of the panel points centered on each touch point, and calculating the mapped coordinates of the touch pixels using the input touch levels of the panel points in the mask as weight values.

The mask may include the panel points arranged in a plurality of rows and a plurality of columns centered on each touch point.

According to one or more exemplary embodiments, there is provided a method of performing near-touch separation in a touch panel, the touch panel having a plurality of panel points for sensing respective input touch levels, the method comprising determining one or more touch groups based on valid touch levels among the input touch levels, each touch group corresponding to the panel points that have valid touch levels and are adjacent in the touch panel; determining a pattern of each touch group from among a row-directional pattern and a column-directional pattern; and separating the touch points in each touch group based on the pattern of each touch group to provide coordinates of the touch points.

The touch points in each touch group may be separated by obtaining candidate coordinates of the panel points having maximum valid touch levels in each row or in each column of each touch group depending on the pattern of each touch group, and comparing the maximum valid touch levels to determine the coordinates of the touch points among the candidate coordinates.

A noise reference level may be determined adaptively depending on the distribution of the input touch levels, the input touch levels that are less than the noise reference level may be removed as noise touch levels, and the input touch levels that are equal to or greater than the noise reference level may be retained as the valid touch levels.

According to an aspect of another exemplary embodiment, there is provided a device including a touch screen including a touch panel and a display panel, the touch panel having a plurality of panel points for sensing respective input touch levels; a touch panel control unit configured to determine valid touch levels by adaptively removing noise touch levels among the input touch levels depending on a distribution of the input touch levels, and configured to determine one or more touch points among the panel points by performing near-touch separation based on a two-dimensional pattern of the valid touch levels; and a display driver configured to control the display panel to display an image on the display panel.

### BRIEF DESCRIPTION OF THE DRAWINGS

Illustrative, non-limiting exemplary embodiments will be more clearly understood from the following detailed description taken in conjunction with the accompanying drawings, in which:

FIG. 1 is a flowchart illustrating a method of detecting multi-touch in a touch panel according to exemplary embodiments;

FIG. 2 is a block diagram illustrating a device including a touch panel according to exemplary embodiments;

FIG. 3 is a block diagram illustrating a multi-touch detector according to exemplary embodiments;

FIG. 4 is a flowchart illustrating a method of determining valid touch levels according to exemplary embodiments;

FIG. 5 is a diagram illustrating an example of input frame data provided from the touch panel of FIG. 2;

FIG. 6 is a diagram illustrating valid frame data determined from the input frame data of FIG. 5;

FIG. 7 is a flowchart illustrating a method of determining a noise reference level according to exemplary embodiments;

FIG. 8 is a flowchart illustrating an example of determining a noise reference level of FIG. 7;

FIG. 9 is a flowchart illustrating another example of determining a noise reference level of FIG. 7;

FIG. 10 is a flowchart illustrating a method of determining touch points by performing near-touch separation according to exemplary embodiments;

FIG. 11 is a flowchart illustrating an example of generating a binary map in the method of FIG. 10;

FIG. 12 is a diagram illustrating a binary map generated from the input frame data of FIG. 5;

FIGS. 13A and 13B are diagrams for describing examples of scanning a binary map to determine touch groups;

FIGS. 14A and 14B are diagrams illustrating other examples of a kernel for scanning a binary map;

FIG. 15 is a flowchart illustrating an example of scanning a binary map to determine touch groups in the method of FIG. 10;

FIG. 16 is a diagram for describing an example of determining each pattern of each touch group in the method of FIG. 10;

FIG. 17 is a diagram illustrating a method of performing near-touch separation in a touch panel according to exemplary embodiments;

FIG. 18 is a diagram for describing an example of providing coordinates of touch points in the method of FIG. 17;

FIG. 19 is a diagram illustrating an example of scanning a binary map to determine touch groups in the method of FIG. 10;

FIG. 20 is a diagram illustrating valid frame data determined from an input frame provided from the touch panel of FIG. 2;

FIG. 21 is a diagram illustrating a binary map corresponding to the valid frame data of FIG. 20;

FIG. 22 is a diagram for describing an example of providing coordinates of touch points in the method of FIG. 17;

FIG. 23 is a block diagram illustrating a touch screen device according to exemplary embodiments;

FIG. 24 illustrates an example of multi-touch performed in a touch screen;

FIG. 25 is a diagram illustrating an example of a touch panel resolution and a display panel resolution;

FIG. 26 is a diagram illustrating an example mapping relation between coordinates of a touch panel and coordinates of a display panel;

FIG. 27 is a flowchart illustrating a method of operating a touch screen according to exemplary embodiments;

FIG. 28 is a diagram for describing an example of extracting mapped coordinates of touch pixels in the method of FIG. 27; and

FIG. 29 is a block diagram illustrating a touch screen device according to exemplary embodiments.

### DETAILED DESCRIPTION

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein. Rather, these exemplary embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular exemplary embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “unit” as used herein means a hardware component and/or a software component that is executed by a hardware component such as a processor.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

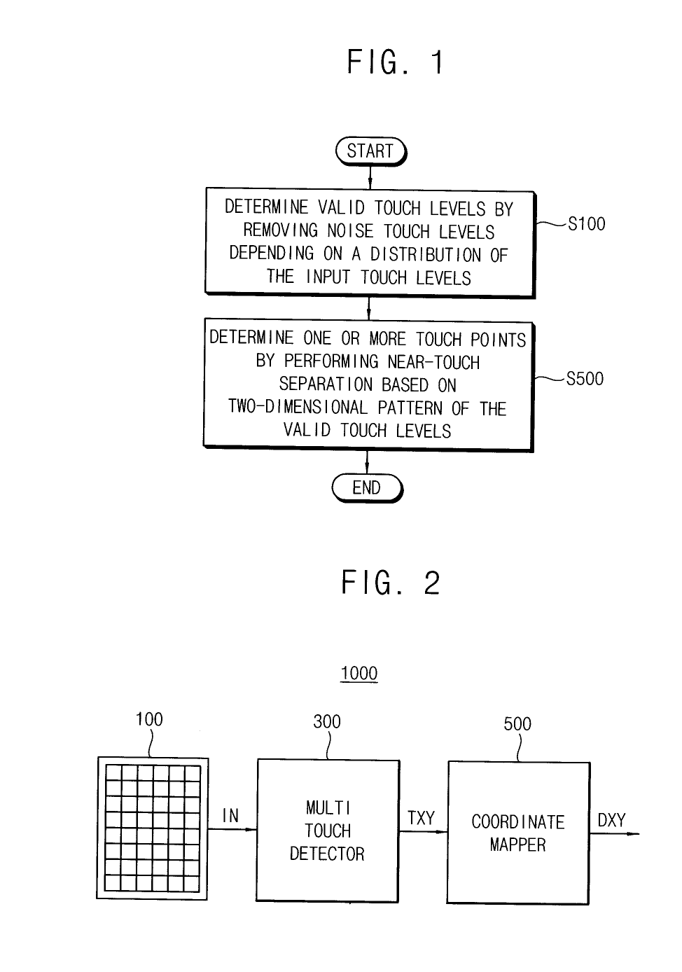

FIG. 1 is a flowchart illustrating a method of detecting multi-touch in a touch panel according to exemplary embodiments.

Referring to FIG. 1, to detect multi-touch in a touch panel that has a plurality of panel points for sensing respective input touch levels, valid touch levels are determined by removing noise touch levels among the input touch levels adaptively depending on a distribution of the input touch levels (S100). One or more touch points are determined among the panel points having the valid touch levels by performing near-touch separation based on a two-dimensional pattern of the valid touch levels (S500). The two-dimensional pattern of the valid touch levels represents a pattern on the touch panel. As will be described, the two-dimensional pattern may include a column-directional pattern and a row-directional pattern.

In this disclosure, multi-touch denotes two or more touches performed on the touch panel substantially at the same time and does not include the touches sequentially performed after a sufficient time interval. The substantially simultaneous touches may represent that the touches are performed within a predetermined time period, for example, a frame period of the touch panel in which one frame data are sensed and provided.

In the method of detecting multi-touch according to exemplary embodiments, noise may be removed adaptively and near-touch may be separated, thereby detecting multi-touch exactly.

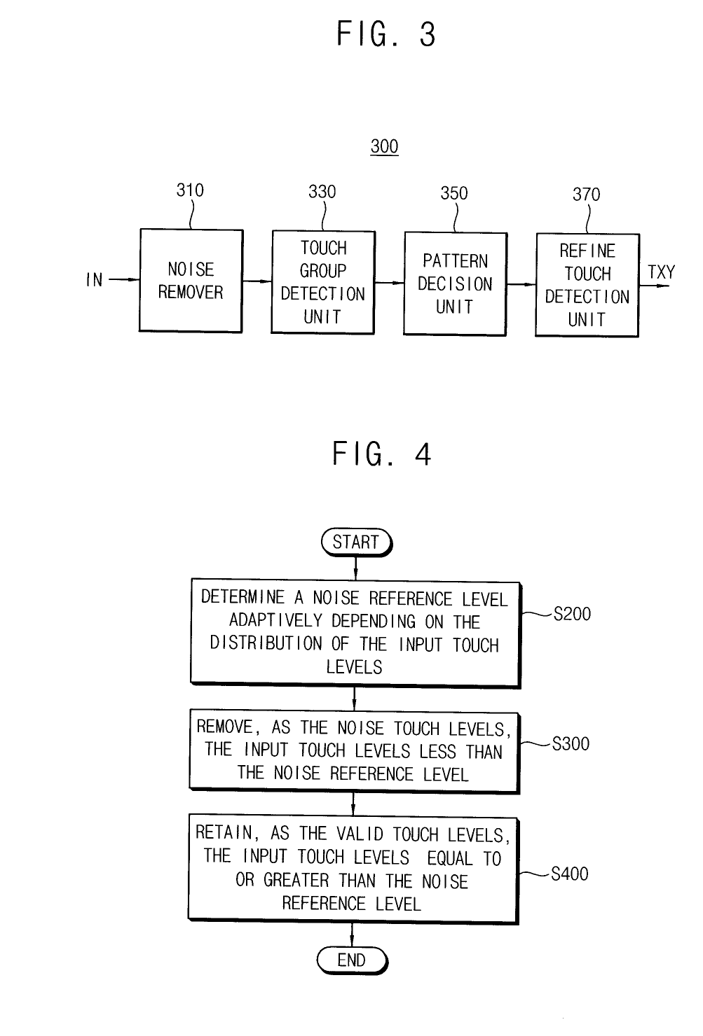

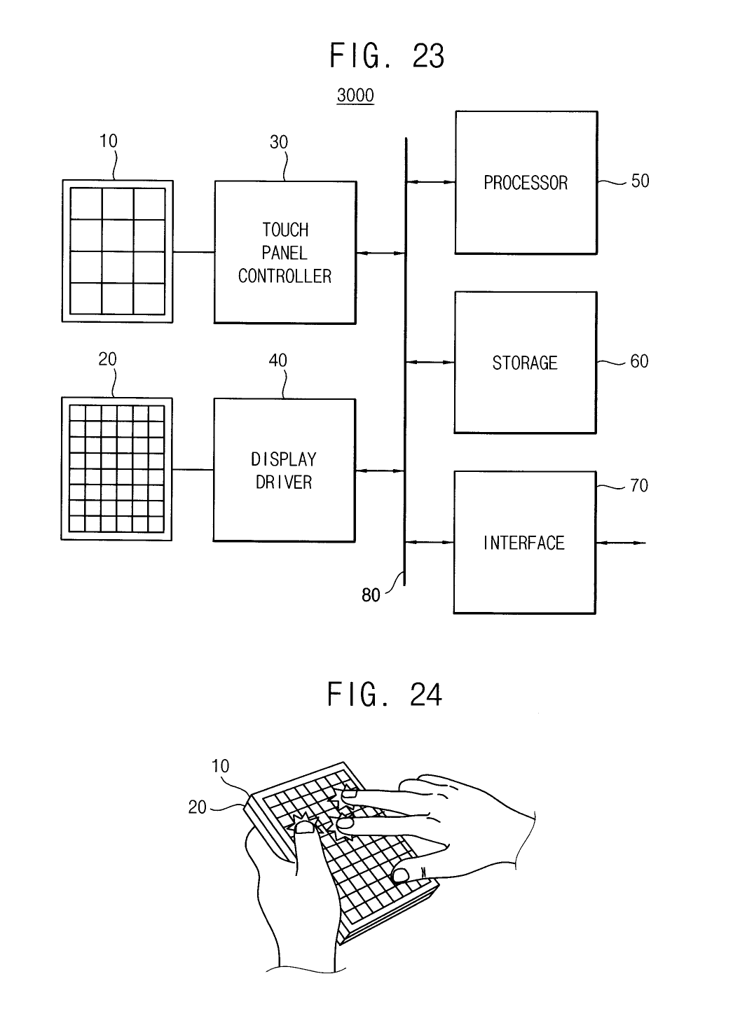

Hereinafter, devices for detecting multi-touch according to exemplary embodiments are described with reference to FIGS. 2 and 3, methods of removing noise adaptively, performing near-touch separation and detecting multi-touch according to exemplary embodiments are described with reference to FIGS. 4 through 22, touch screen devices and methods of operating the touch screen device are described with reference to FIGS. 23 through 28.

FIG. 2 is a block diagram illustrating a device including a touch panel according to exemplary embodiments.

Referring to FIG. 2, a device 1000 includes a touch panel 100 and a multi-touch detector 300. When the device 1000 corresponds to a touch screen device, the touch panel 100 may represent a touch screen including a display panel in addition to a touch panel and the device may further include a coordinate mapper 500.

The touch panel 100 may include a plurality of panel points that are arranged in a matrix of a plurality of columns and a plurality of rows. Each position of the panel points on the touch panel may be designated by (x, y) where x indicates a column coordinate and y indicates a row coordinate. The coordinates to designate the panel point are not limited to a combination of orthogonal coordinates based on coordinate axes perpendicular to each other. Any other coordinate system may be used to designator the coordinates of the panel points. For example, an axis in a diagonal direction may be used to designate one coordinate. As such, a combination of arbitrary two coordinates may be used to designate the position of the panel point on the touch panel 100. Furthermore, it will be easily understood that the present inventive concept may be applicable in case that the column coordinate x and the row coordinate y are exchanged.

The touch panel 100 may be configured to sense a plurality of touches performed by contacts on a plurality of panel points substantially at the same time. In other words, the touch panel 100 may be configured to output a set of input touch levels IN representing a contact intensity or a touch intensity on the respective panel points. The set of the input touch levels IN may be referred to as an input frame data and the input frame data may be provided per a sensing period, that is, a frame period.

The method of detecting multi-touch of FIG. 1 may be performed by the multi-touch detector 300. That is, the multi-touch detector 300 determines valid touch levels by removing noise touch levels among the input touch levels adaptively depending on a distribution of the input touch levels IN and determines one or more touch points TXY among the panel points having the valid touch levels by performing near-touch separation based on a two-dimensional pattern of the valid touch levels. As described above, each position of each touch point may be represented by (x, y) corresponding to the combination of the column coordinate x and the row coordinate y.

When the device 1000 corresponds to a touch screen device, the device 1000 may further include the coordinate mapper 500. A touch screen may represent a single screen that includes a superimposed touch panel and a display panel, and an arbitrary device including such touch screen may be referred to as a touch screen device. The coordinate mapper 500 may extract mapped coordinates DXY of touch pixels in the display panel, where the touch pixels in the display panel correspond to the touch points in the touch panel. In other words, the position of the touch pixel and the position of the corresponding touch point may coincide on the touch screen including the touch panel and the display panel. Through such mapping of the touch panel position to the display panel position, the user may perform input actions including a single-touch action for selecting an icon or a menu item displayed on the touch screen, and a multi-touch action such as a drag, a pinch, a stretch, etc.

FIG. 3 is a block diagram illustrating a multi-touch detector according to exemplary embodiments.

Referring to FIG. 3, a multi-touch detector 300 may include a noise remover 310, a touch group detection unit 330, a pattern decision unit 350 and a refine touch detection unit 370.

The noise remover 310 removes noise touch levels among the input touch levels IN adaptively depending on a distribution of the input touch levels IN. For example, the noise remover 310 may determine a noise reference level NL based on the distribution of the input touch levels IN, and may remove each input touch level IN as a noise touch level or retain each input touch level IN as a valid touch level based on the determined noise reference level NL.

The touch group detection unit 330 may determine one or more touch groups, such that each touch group corresponds to the panel points that have the valid touch levels and are adjacent from each other in the touch panel 100. In an exemplary embodiment, the noise remover 310 may provide a binary map in addition to the valid touch levels. In this case, the touch group detection unit 330 may determine the touch groups by scanning the binary map.

The pattern decision unit 350 may determine each pattern of each touch group among a row-directional pattern and a column-directional pattern. The row-directional pattern may represent that multiple touches in the touch group are arranged in a row-direction and the column-directional pattern may represent that multiple touches in the touch group are arranged in a column-direction. The refine touch detection unit 370 may separate the touch points in each touch group based on each pattern of each touch group to provide coordinates of the touch points. The multiple touches in a single touch group may be referred to as near-touch, and the refine touch detection unit 370 may perform near-touch separation to detect such near-touch to determine one or more touch points in the single touch group.

As such, multi-touch on the two-dimensional touch panel may be detected effectually and exactly through near-touch separation based on the two-dimensional pattern of the valid touch levels. In related art devices, a near-touch cannot be detected and an averaged position of near touches is provided as the coordinates of the touch point. According to exemplary embodiments, near-touch may be detected exactly to the extent permitted by the resolution of the touch panel.

FIG. 4 is a flowchart illustrating a method of determining valid touch levels according to exemplary embodiments.

Referring to FIG. 4, to determine the valid touch levels, a noise reference level NL may be determined based on the distribution of the input touch levels (S200). The input touch levels IN smaller than the determined noise reference level NL may be removed as the noise touch levels (S300), and the input touch levels IN equal to or greater than the determined noise reference level NL may be retained as the valid touch levels VL (S400).

In other words, determination of the noise reference level NL based on the distribution of the input touch levels IN may represent the adaptive removal of noise based on the distribution of the input touch levels IN. If the noise reference level NL is determined uniformly regardless of entire touch intensity (as is the case in the related art), touch detection errors may be increased such that a relatively weak touch may be disregarded as a noise or the panel point unintended by the user may be detected as the touch point in case that the entire touch intensity is relatively strong.

By contrast, according to exemplary embodiments, the input touch action of variable touch intensity by the user may be detected effectually by removing the noise adaptively based on the distribution of the input touch levels.

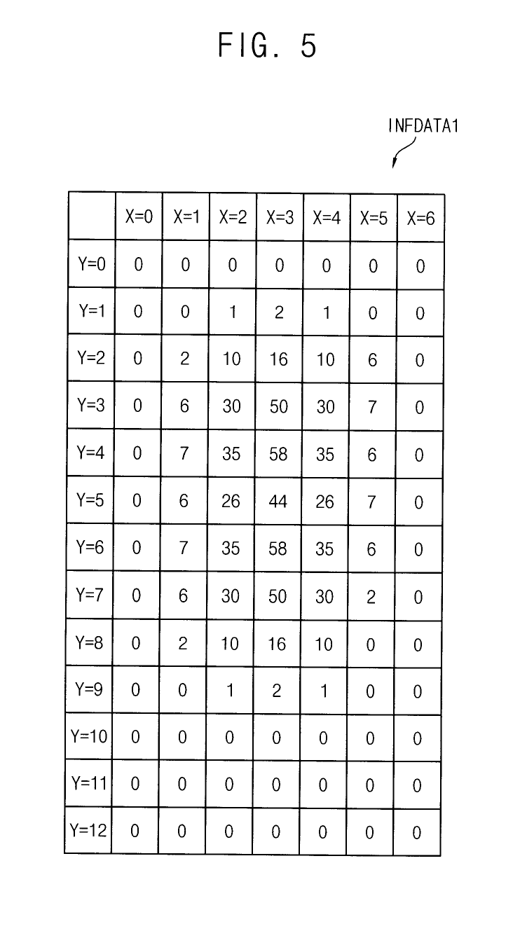

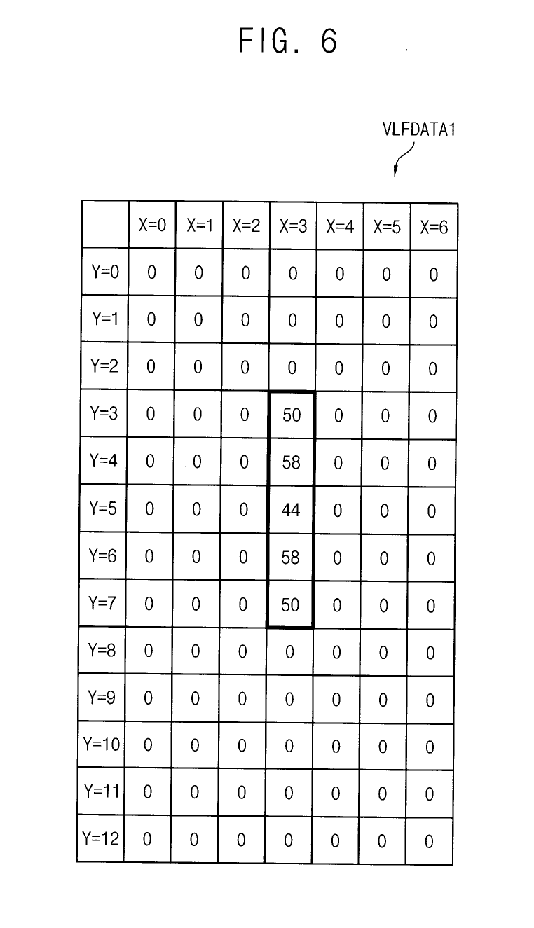

FIG. 5 is a diagram illustrating an example of input frame data provided from the touch panel of FIG. 2, and FIG. 6 is a diagram illustrating valid frame data determined from the input frame data of FIG. 5.

Input frame data INFDATA1 is illustrated in FIG. 5, which are sensed during a frame period corresponding to one sensing time period of the touch panel. The input frame data INFDATA1 includes the input touch levels IN corresponding to all of the panel points in the touch panel. Input frame data INFDATA1 having seven columns (X=0 to 6) and thirteen rows (Y=0 to 12) is illustrated in FIG. 5 for convenience of description. However, the numbers of the columns and the rows of the input frame data may be varied depending on the resolution of the touch panel or an activated window corresponding to a portion of the touch panel.

Each input touch level corresponding to one panel point of the touch panel may be represented by a digital value of n bits, where n is a positive integer. For example, each input touch level may be one of 64 values from 0 to 63 when the input touch level is represented by six bits, or each input touch level may be one of 256 values from 0 to 255 when the input touch level is represented by eight bits. When the touch panel outputs analog signals, the analog signals may be converted to the digital values as illustrated in FIG. 5 using an analog-to-digital converter.

For example, referring to FIG. 5, the coordinates of the panel point of the third column (x=2) and the fourth row (y=3) may be represented as (x, y)=(2, 3) and the input touch level of that point is 30. The relation between the panel points and the corresponding input touch level may be represented as IN(2, 3)=30.

For example, when the noise reference level NL is determined to be 35, the input touch levels less than 35 may be removed as noise and the input touch levels equal to or greater than 35 may be retained as valid touch levels. The valid frame data VLFDATA1 determined from the input frame data INFDATA1 as such is illustrated in FIG. 6.

Referring to FIG. 6, the valid frame data VLFDATA1 includes five valid touch levels and the relations between the panel points (x, y) and the corresponding valid touch levels VL(x, y) may be represented as VL(3, 3)=50, VL(3, 4)=58, VL(3, 5)=44, VL(3, 6)=58 and VL(3, 7)=50. The value of 0 may be imposed uniformly to the panel points corresponding to the input touch levels removed as noises as illustrated in FIG. 6. For example, with respect to the panel point (2, 3), the input touch level may be represented as IN(2, 3)=30 that is considered as a noise and the valid touch level may be represented as VL(2, 3)=0.

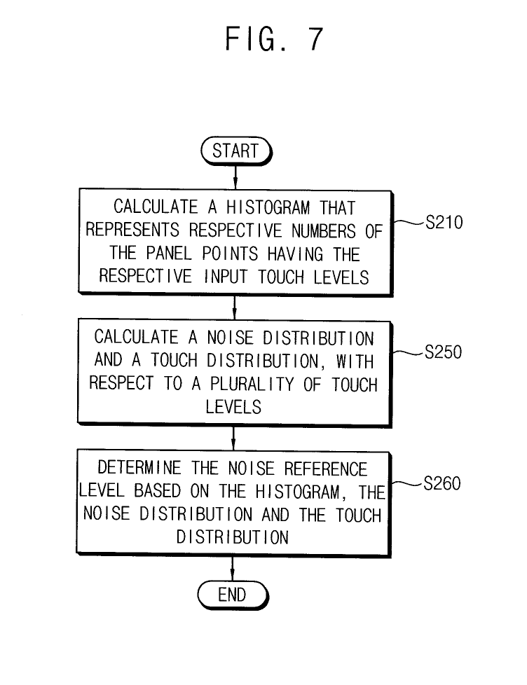

FIG. 7 is a flowchart illustrating a method of determining a noise reference level according to exemplary embodiments.

Referring to FIG. 7, a histogram HST, which represents respective numbers of the panel points having the respective input touch levels, is determined (S210). A noise distribution and a touch distribution are calculated with respect to a plurality of threshold touch levels (S250), where the noise distribution is calculated from the input touch levels less than a threshold touch level, and the touch distribution is calculated from the input touch levels equal to or greater than the threshold touch level. The noise distribution and the touch distribution may include a respective mean value and/or a respective variance value. The noise reference level NL may be determined based on the histogram HST, the noise distribution and the touch distribution (S260). For example, the noise reference level NL may be determined by applying respective weight values of the histogram HST to the noise distribution and the touch distribution.

As such, the noise reference level appropriate for the distribution of the input touch levels IN may be determined adaptively based on the noise distribution, the touch distribution and the histogram weight values.

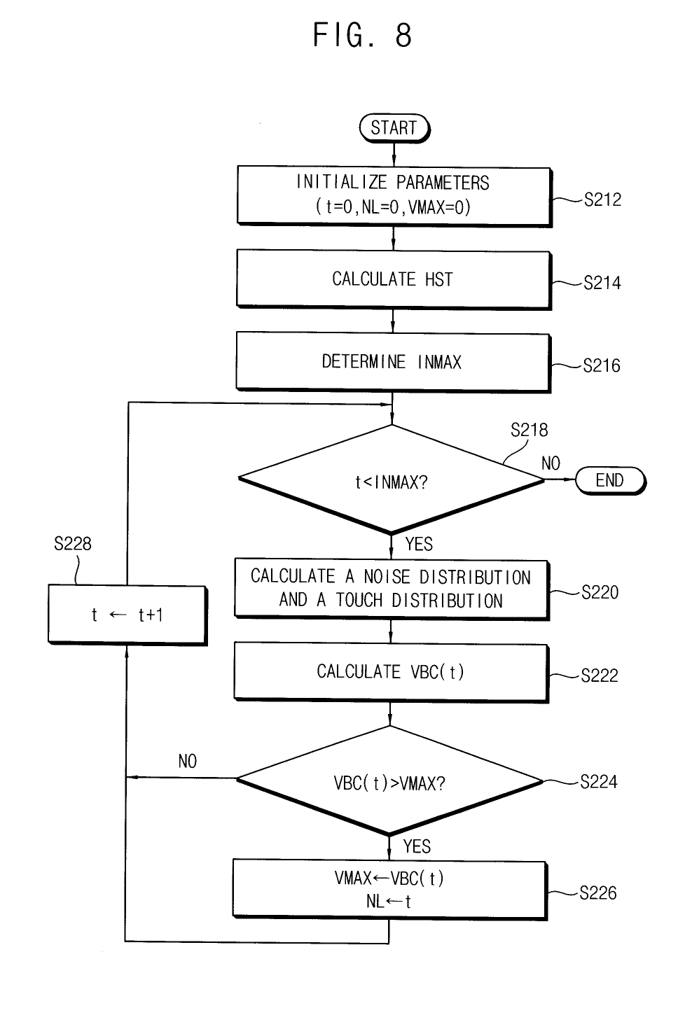

FIG. 8 is a flowchart illustrating an example of determining a noise reference level of FIG. 7.

Referring to FIG. 8, parameters for determining the noise reference level NL finally are initialized (S212). For example, a threshold touch level t is set to 0, a noise reference level NL is set to 0 and a maximum variance value VMAX is set to 0.

A histogram HST is calculated (S214) such that the respective number Ni of the panel points having the respective input touch level i may be represented by HST(i)=Ni, and a maximum input touch level INMAX is determined (S216).

For example, in case of the input frame data INFDATA1 of FIG. 5, the histogram HST may be represented as HST(0)=51, HST(1)=4, HST(2)=5, HST(6)=6, HST(7)=4, HST(10)=4, HST(16)=2, HST(26)=2, HST(30)=4, HST(35)=4, HST(44)=1, HST(50)=2, HST(58)=2, and HST(j)=0 with respect to the other input touch levels j. The sum of all HST(i) corresponds to the total number of the panel points included in the touch panel. In case of FIG. 5, the total number of the panel points is 91, and the maximum input touch level INMAX is 58.

When the threshold touch level t is less than the maximum input touch level INMAX (S218: YES), the noise distribution and the touch distribution are calculated (S220). The noise distribution represents a distribution of the input touch levels less than the threshold touch level t, and the touch distribution represents a distribution of the input touch levels equal to or greater than the threshold touch level t. Each of the noise distribution and the touch distribution may be represented by the respective mean value and/or the respective variance value. In other words, with respect to the threshold touch level t, the noise distribution may be represented by the noise mean value MN(t) and/or the noise variance value VN(t), and the touch distribution may be represented by the touch mean value MT(t) and the touch variance value VT(t), which may be calculated using Expressions 1, 2, 3 and 4.

$$\begin{matrix}MN ( t ) = \frac{{\sum }_{i = 0}^{t - 1} [ i \times HST ( i ) ]}{{\sum }_{i = 0}^{t - 1} HST ( i )} & ( Expression 1 ) \\ VN ( t ) = \frac{{\sum }_{i = 0}^{t - 1} [ {( i - MN ( t ) )}^{2} \times HST ( i ) ]}{{\sum }_{i = 0}^{t - 1} HST ( i )} & ( Expression 2 ) \\ MT ( t ) = \frac{{\sum }_{i = 0}^{n - 1} [ i \times HST ( i ) ]}{{\sum }_{i = t}^{n - 1} HST ( i )} & ( Expression 3 ) \\ VT ( t ) = \frac{{\sum }_{i = t}^{n - 1} [ {( i - MT ( t ) )}^{2} \times HST ( i ) ]}{{\sum }_{i = t}^{n - 1} HST ( i )} & ( Expression 4 )\end{matrix}$$

In the Expressions 3 and 4, n denotes the maximum input touch level INMAX.

A between-class variance value VBC(t) is calculated (S222) by applying histogram weight values to the noise distribution and the touch distribution as in Expression 5.

VBC(t)=WN(t)×WT(t)×[MN(t)−MT(t)]² (Expression 5)

In Expression 5, WN(t) denotes a noise histogram weight value and WT(t) denotes a touch histogram weight value, which may be calculated as in Expressions 6 and 7.

$$\begin{matrix}WN ( t ) = \frac{{\sum }_{i = 0}^{t - 1} HST ( i )}{{\sum }_{i = 0}^{n - 1} HST ( i )} & ( Expression 6 ) \\ WT ( t ) = \frac{{\sum }_{i = t}^{n - 1} HST ( i )}{{\sum }_{i = 0}^{n - 1} HST ( i )} & ( Expression 7 )\end{matrix}$$

When the between-class variance value VBC(t) is greater than the maximum variance value VMAX (S224: YES), the maximum variance value VMAX is upgraded with the between-class variance value VBC(t) and the noise reference level NL is upgraded with the threshold touch level t (S226). When the between-class variance value VBC(t) is not greater than the maximum variance value VMAX (S224: NO), the maximum variance value VMAX and the noise reference level NL are not upgraded and maintain the previous values with respect to the threshold touch level t−1.

The threshold touch level t is increased by 1 (S228) and the above mentioned S218, S220, S222, S224, S226 and S228 are repeated for all the threshold touch levels t less than the maximum input touch level INMAX. When the threshold touch level t is not smaller than the maximum input touch level INMAX (S218: NO), the above mentioned repetition is stopped and the noise reference level NL is determined finally.

As a result, the noise reference level NL is finally set to the threshold touch level t that gives a maximum value of the between-class variance value VBC(t).

As such, the noise reference level NL may be determined based on the distribution of the input touch levels and the noises may be removed using the determined noise reference level NL, thereby effectually detecting the input touch action of variable touch intensity by the user.

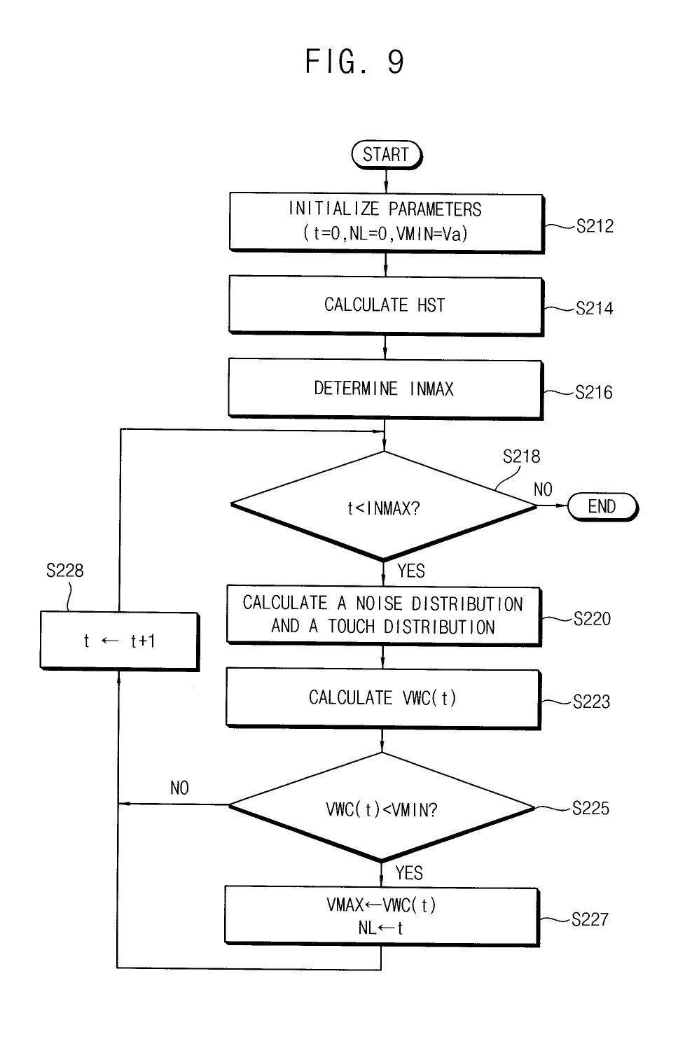

FIG. 9 is a flowchart illustrating another example of determining a noise reference level of FIG. 7.

Referring to FIG. 9, parameters for determining a noise reference level NL finally are initialized (S212). For example, a threshold touch level t is set to 0 and a noise reference level NL is set to 0. A minimum variance value VMIN is set to Va of a sufficiently large value.

A histogram HST is calculated (S214) such that the respective number Ni of the panel points having the respective input touch level i may be represented by HST(i)=Ni, and a maximum input touch level INMAX is determined (S216), as was described above with reference to FIG. 8.

When the threshold touch level t is less than the maximum input touch level INMAX (S218: YES), the noise distribution and the touch distribution are calculated (S220). The calculation of the noise distribution and the touch distribution are the same as described with reference to FIG. 8.

A within-class variance value VWC(t) is calculated (S223) by applying histogram weight values to the noise distribution and the touch distribution as in Expression 8.

VWC(t)=WN(t)×VN(t)+WT(t)×VT(t) (Expression 8)

In Expression 8, the noise variance value VN(t) and the touch variance value VT(t) are the same as Expressions 2 and 4, and the noise histogram weight value WN(t) and the touch histogram weight value are the same as Expressions 6 and 7.

When the within-class variance value VWC(t) is less than the minimum variance value VMIN (S225: YES), the minimum variance value VMIN is upgraded with the within-class variance value VWC(t) and the noise reference level NL is upgraded with the threshold touch level t (S227). When the within-class variance value VWC(t) is not less than the minimum variance value VMIN (S225: NO), the minimum variance value VMIN and the noise reference level NL are not upgraded and maintain the previous values with respect to the threshold touch level t−1.

The threshold touch level t is increased by 1 (S228) and the above mentioned S218, S220, S223, S225, S227 and S228 are repeated for all the threshold touch levels t less than the maximum input touch level INMAX. When the threshold touch level t is not less than the maximum input touch level INMAX (S218: NO), the above mentioned repetition is stopped and the noise reference level NL is determined finally.

As a result, the noise reference level NL is set to the threshold touch level t that gives a minimum value of the within-class variance value VWC(t).

As such, the noise reference level NL may be determined based on the distribution of the input touch levels and the noise may be removed using the determined noise reference level NL, thereby effectually detecting the input touch action of variable touch intensity by the user.

The maximum of the between-class variance value VBC(t) obtained by the method of FIG. 8 is mathematically equivalent to the minimum of the within-class variance value VWC(t) obtained by the method of FIG. 9.

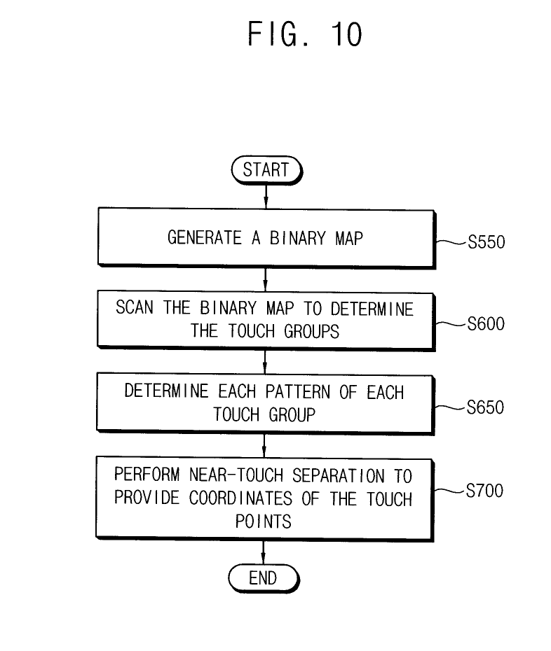

FIG. 10 is a flowchart illustrating a method of determining touch points by performing near-touch separation according to exemplary embodiments.

Referring to FIG. 10, one or more touch groups are determined such that each touch group corresponds to the panel points that have the valid touch levels and are adjacent from each other in the touch panel. In an exemplary embodiment, a binary map may be generated (S550) by assigning a first value to the panel points having the valid touch levels and by assigning a second value to the panel points having the noise touch level, and then the binary map may be scanned to determine the touch groups (S600).

After the touch groups are determined, each pattern of each touch group is determined among a row-directional pattern and a column-directional pattern (S650). The touch points in each touch group are separated based on each pattern of each touch group to provide coordinates of the touch points (S700).

As such, the pattern of the touch group may be determined first and near-touch separation is performed based on the determined pattern, thereby effectually detecting near touch points through analysis of a two-dimensional edge map.

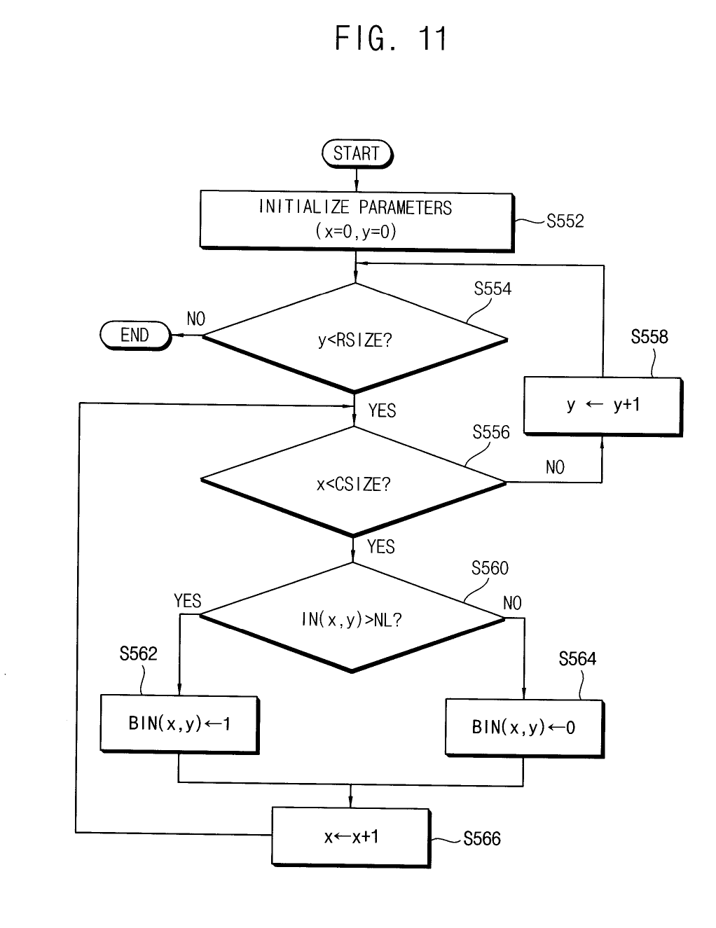

FIG. 11 is a flowchart illustrating an example of generating a binary map in the method of FIG. 10.

Referring to FIG. 11, parameters for generating a binary map are initialized (S552). For example, a start point is set to (0, 0) by initializing the column coordinate x and the row coordinate y. The noise reference level NL is set to the value obtained by the method described with reference to FIGS. 7, 8 and 9. The row size RSIZE and the column size CSIZE are set to the column number and the row number of the touch panel. For example, in case of a touch panel having resolution of FIG. 5, the row size RSIZE is set to 13 and the column size CSIZE is set to 7.

When the row coordinate y is less than the row size RSIZE (S554: YES), the column coordinate x is compared with the column size CSIZE (S556). When the row coordinate y is not less than the row size RSIZE (S554: NO), the binary map is generated since the binary values are assigned to all the panel points.

When the column coordinate x is less than the column size CSIZE (S556: YES), the input touch level IN(x, y) of the current panel point (x, y) is compared with the noise reference level NL (S560). When the column coordinate x is not less than the column size CSIZE (S556: NO), the row coordinate y is increased by 1 (S558) and the row coordinate y is compared with the row size RSIZE (S554).

When the input touch level IN(x, y) is greater than the noise reference level NL (S560: YES), a first value is assigned to the binary value BIN(x, y) of the current panel point (x, y) (S562). When the input touch level IN(x, y) is not greater than the noise reference level NL (S560: NO), a second value is assigned to the binary value BIN(x, y) of the current panel point (x, y) (S564). For example, the first value may be 1 and the second value may be 0. After the binary value BIN(x, y) of the current panel point (x, y) is assigned (S562 and S564), the column coordinate x is increased by 1 (S566), and the column coordinate x is compared with the column size CSIZE (S556).

As a result, with respect to all panel points (0, 0) through (CSIZE−1, RSIZE−1), the first value is assigned to the panel points having the input touch levels greater than the noise reference level NL, and the second value is assigned to the other panel points.

As such, the binary map may be generated by comparing each input touch level IN with the noise reference level NL.

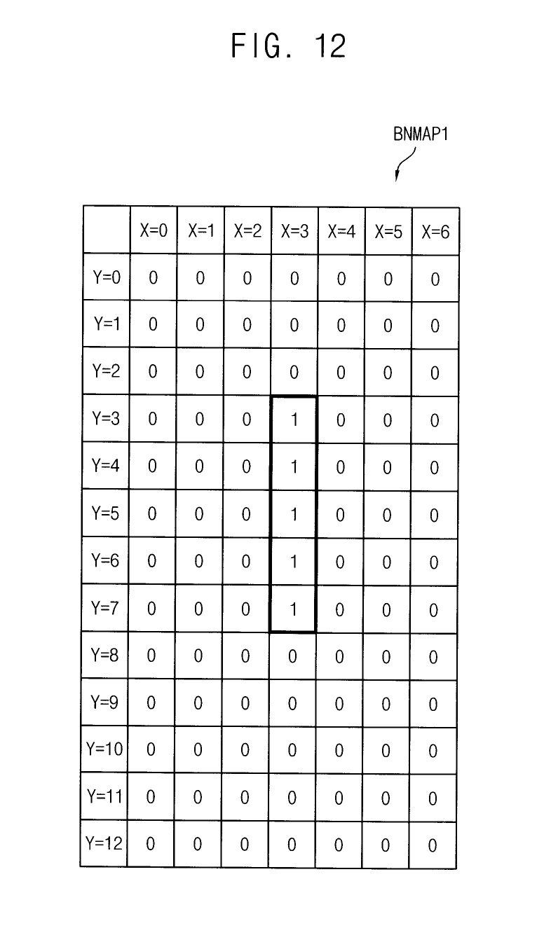

FIG. 12 is a diagram illustrating a binary map generated from the input frame data of FIG. 5.

As described above, the noise reference level NL is determined to 35 with respect to the distribution of the input touch levels of FIG. 5. The five panel points (3, 3), (3, 4), (3, 5), (3, 6) and (3, 7) in the input frame data INFDATA1 of FIG. 5 have the valid touch levels greater than the noise reference level NL and the other panel points have the noise touch levels.

Referring to the binary map NMMAP1 of FIG. 12, the first value of 1 is assigned to the five panel points (3, 3), (3, 4), (3, 5), (3, 6) and (3, 7) having the valid touch levels and the second value of 0 is assigned to the other panel points having the noise touch levels.

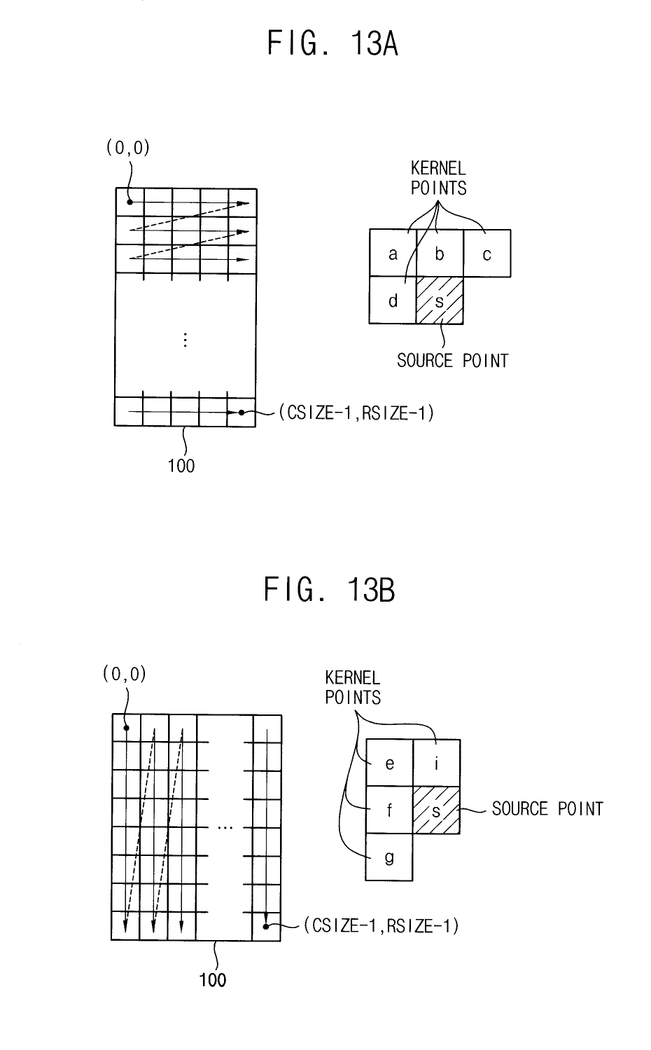

FIG. 13A is a diagram for describing an example of scanning a binary map to determine touch groups.

An example method of scanning the binary map and a corresponding method of setting a kernel are illustrated in FIG. 13A. The kernel includes kernel points a, b, c and d adjacent to a source point s.

Referring to FIG. 13A, the binary map may be scanned for all of the source points (x, y) starting from the source point (0, 0) to the source point (CSIZE−1, RSIZE−1) such that the column coordinate x is sequentially increased first and the row coordinate y is increased when one row is scanned. In this case, with respect to each source point (x, y), the four kernel points may be set to a=(x−1, y−1), b=(x, y−1), c=(x+1, y−1) and d=(x−1, y) as illustrated in FIG. 13A.

In case of the source point s=(0, 0), the kernel points correspond to a=(−1, −1), b=(0, −1), c=(1, −1) and d=(−1, 0), which do not exist in the touch panel. In this case, the binary value of 0 may be designated uniformly to the non-existing kernel points. In other words, BIN(x, −1) and BIN(−1, y) are set to 0 with respect to all of x and y.

The calculation amount may be reduced using such scanning method and the corresponding kernel, and the touch groups may be determined effectually by judging whether the source points are adjacent to each other.

FIG. 13B is a diagram for describing another example of scanning a binary map to determine touch groups.

An example method of scanning the binary map and a corresponding method of setting a kernel are illustrated in FIG. 13B. The kernel includes kernel points e, f, g and i adjacent to a source point s.

Referring to FIG. 13B, the binary map may be scanned for all of the source points (x, y) starting from the source point (0, 0) to the source point (CSIZE−1, RSIZE−1) such that the row coordinate y is increased first and the column coordinate x is increased when one column is scanned. In this case, with respect to each source point (x, y), the four kernel points may be set to e=(x−1, y−1), f=(x−1, y), g=(x−1, y+1) and i=(x, y−1) as illustrated in FIG. 13B.

In case of the source point s=(0, 0), the kernel points correspond to e=(−1, −1), f=(−1, 0), g=(−1, 1) and i=(0, −1), which do not exist in the touch panel. In this case, the binary value of 0 may be designated uniformly to the non-existing kernel points. In other words, BIN(x, −1) and BIN(−1, y) are set to 0 with respect to all of x and y.

The calculation amount may be reduced using such scanning method and the corresponding kernel, and the touch groups may be determined effectually by judging whether the source points are adjacent to each other.

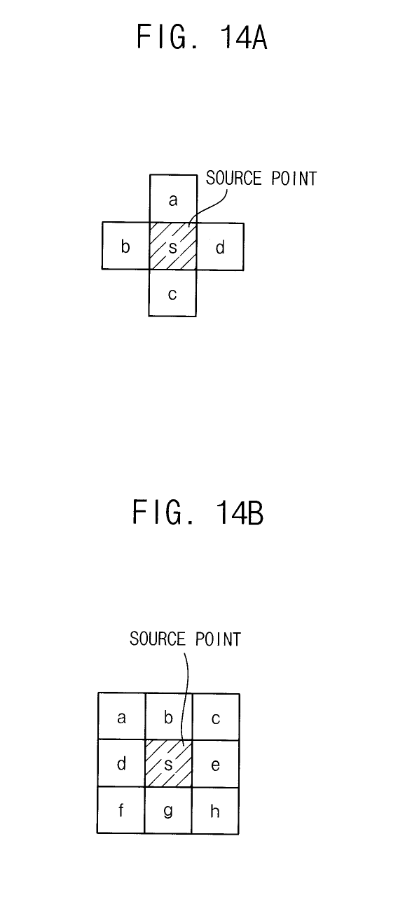

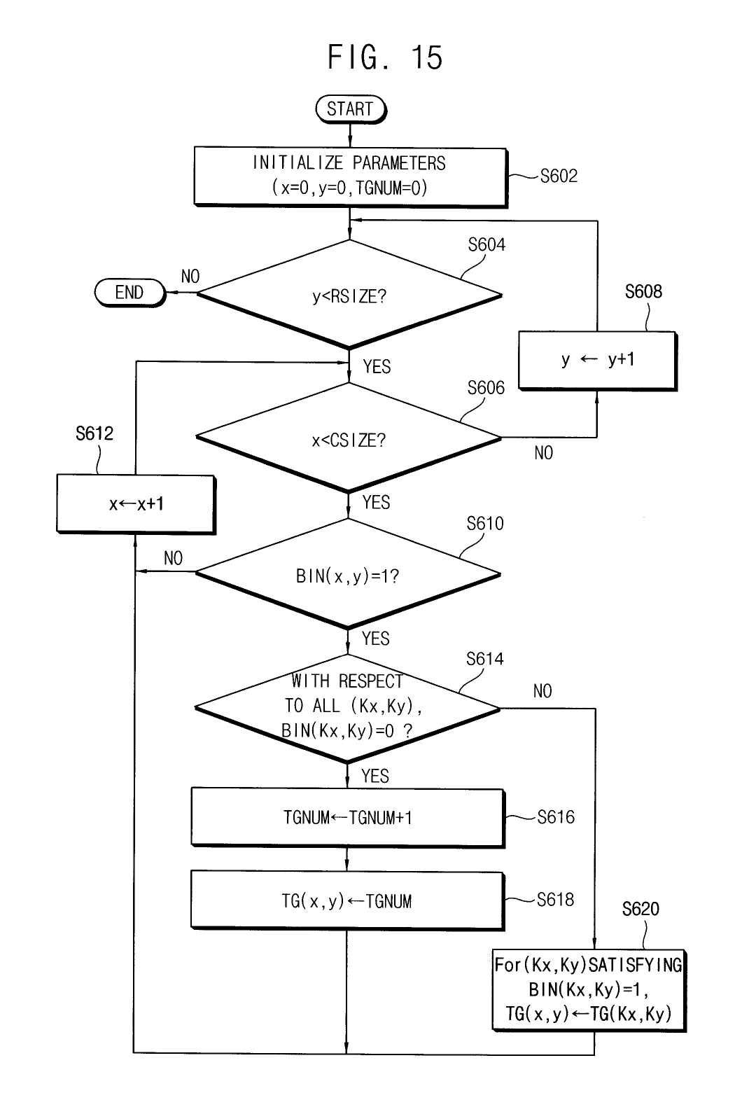

FIGS. 14A and 14B are diagrams illustrating other examples of a kernel for scanning a binary map.

Referring to FIG. 14A, a kernel for scanning a binary map may include four kernel points a, b, c and d adjacent to the source point s in the column direction and the row direction. That is, with respect to each source point (x, y), the kernel points may be set to a=(x, y−1), b=(x−1, y), c=(x, y+1) and d=(x+1, y).

Referring to FIG. 14B, a kernel for scanning a binary map may include eight kernel points a, b, c, d, e, f, g and h adjacent to the source point s in the column direction, the row direction and the diagonal directions. That is, with respect to each source point (x, y), the kernel points may be set to a=(x−1, y−1), b=(x, y−1), c=(x+1, y−1), d=(x−1, y), e=(x+1, y), f=(x−1, y+1), g=(x, y+1) and h=(x+1, y+1).

When using the kernels of FIGS. 14A and 14B, there is no limit to scanning method as compared with the kernels illustrated in FIGS. 13A and 13B. In case of the kernel of FIG. 14A, however, the panel points having valid touch levels adjacent in the diagonal direction may not be considered as belonging to the same touch group. The calculation amount may be increased in case of the kernel of FIG. 14B since the kernel includes the relatively large number of kernel points.

FIG. 15 is a flowchart illustrating an example of scanning a binary map to determine touch groups in the method of FIG. 10. FIG. 15 illustrates determining the touch groups according to the scanning method and the kernel of FIG. 13A.

Referring to FIG. 15, parameters for scanning a binary map to determine one or more touch groups are initialized (S602). For example, a start point is set to (0, 0) by initializing the column coordinate x and the row coordinate y. The row size RSIZE and the column size CSIZE are set to the column number and the row number of the touch panel. A touch group number TGNUM is set to 0. With respect to all points (x, y), a touch group serial number TG(x, y) is set to 0.

When the row coordinate y is less than the row size RSIZE (S604: YES), the column coordinate x is compared with the column size CSIZE (S606). When the row coordinate y is not less than the row size RSIZE (S604: NO), the determination of the touch groups is finished since scanning is performed with respect to all panel points.

When the column coordinate x is less than the column size CSIZE (S606: YES), the binary value BIN(x, y) of the current source point is compared with the first value, that is, 1 (S610). When the column coordinate x is not less than the column size CSIZE (S606: NO), the row coordinate y is increased by 1 (S608) since scanning one row is finished, and the row coordinate y is compared with the row size RSIZE (S604).

When the binary value BIN(x, y) of the source point (x, y) is 1 (that is, the first value) (S610: YES), it is determined whether the binary value BIN(Kx, Ky) is 0 (that is, the second value) with respect to all kernel points (Kx, Ky) (S614). For example, the kernel points (Kx, Ky) may be set to a=(x−1, y−1), b=(x, y−1), c=(x+1, y−1) and d=(x−1, y) with respect to each source point (x, y) as described above with reference to FIG. 13A. When the binary value BIN(x, y) of the source point (x, y) is 0 (that is, the second value) (S610: NO), the column coordinate x is increased by 1 (S612) and then the column coordinate x is compared with the column size CSIZE (S606).

When the binary value BIN(Kx, Ky) is 0 with respect to for all kernel points (Kx, Ky) (S614: YES), which indicates that a new touch group is detected, the touch group number TGNUM is increased by 1 (S616), and then the touch group number TGNUM is assigned to the touch group serial number TG(x, y) (S616) of the current source point (x, y) as represented by TG(x, y)=TGNUM. In this way, it may be represented that the current source point (x, y) belongs to the TGNUM-th touch group. The column coordinate x is increased by 1 (S612) and the column coordinate x is compared with the column size CSIZE (S606).

When the binary value BIN(Kx, Ky) is not 0 with respect to all kernel points (Kx, Ky) (S614: NO), the touch group serial number TG(Kx, Ky) of the kernel point satisfying BIN(Kx, Ky)=1 is assigned to the touch group serial number TG(x, y) of the current source point (x, y) (S620) as represented by TG(x, y)=TG(Kx, Ky). In this way, it may be represented that the current source point (x, y) and the kernel point (Kx, Ky) satisfying BIN(Kx, Ky)=1 belong to the same touch group. In this case (S614: NO), since a new touch is not detected, without increasing the touch group number TGNUM, the column coordinate x is increased by 1 (S612) and the column coordinate x is compared with the column size CSIZE (S606).

As a result, the touch group serial number TG(x, y) is assigned for all panel points (x, y) of the touch panel, and the number of the detected touch groups corresponds to the finally determined TGNUM.

For example, in case of the binary map BNMAT1 of FIG. 12, the total number of the touch groups is determined to 1, 1 is assigned to the touch group serial number TG(x, y) for the five source points (3, 3), (3, 4), (3, 5), (3, 6) and (3, 7), and the initialize value 0 is assigned to TG(x, y) for the other source points.

As such, by scanning the binary map, one or more touch groups may be determined such that each touch group corresponds to the panel points that have the valid touch levels and are adjacent from each other in the touch panel.

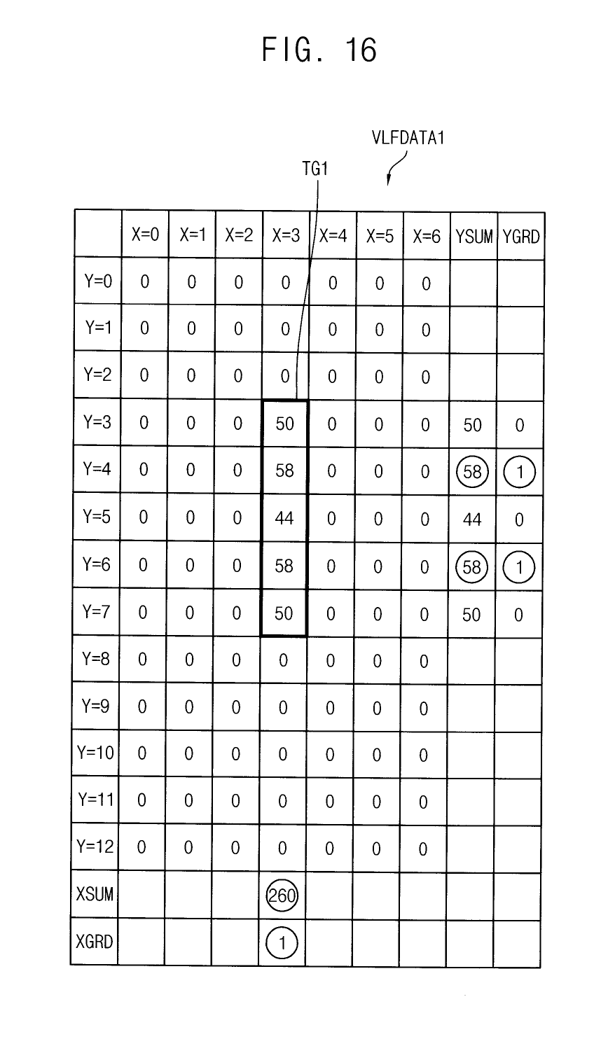

FIG. 16 is a diagram for describing an example of determining each pattern of each touch group in the method of FIG. 10.

Referring to FIG. 16, a column-directional edge value is determined such that the column-directional edge value corresponds to a number of peak maximum values of row-directional sums YSUM. Each row-directional sum YSUM is obtained by adding the valid touch levels of the panel points in each row of each touch group TG1. In case of the touch group TG1 in the valid frame data VLFDATA1 of FIG. 16, the row-directional sums YSUM of the fifth row (y=4) and the seventh row (y=6) correspond to the peak-maximum values compared with the adjacent rows, and row gradients YGRD of the fifth row (y=4) and the seventh row (y=6) are determined to 1. The sum of the row gradients YGRD is determined to the column-directional edge value, which is 2 in case of the touch group TG1 of FIG. 16.

Similarly, a row-directional edge value is determined such that row-directional edge value corresponds to a number of peak maximum values of column-directional sums XSUM. Each column-directional sum XSUM is obtained by adding the valid touch levels of the panel points in each column of each touch group TG1. In case of the touch group TG1 in the valid frame data VLFDATA1 of FIG. 16, the column-directional sum XSUM of the fourth column (x=3) corresponds to the peak-maximum values compared with the adjacent columns, and column gradients XGRD of the fourth column (x=4) is determined to 1. The sum of the column gradients XGRD is determined to the row-directional edge value, which is 1 in case of the touch group TG1 of FIG. 16.

Each pattern of each touch group is determined by comparing the column-directional edge value and the row-directional edge value. In case of the touch group TG1 of FIG. 16, the pattern is determined to the column-directional pattern (or the vertical pattern) since the column-directional edge value is greater than the row-directional edge value. If the row-directional edge value is greater than the column-directional edge value, the pattern of the touch group is determined to the row-directional pattern (or the horizontal pattern). If the row-directional edge value is equal to the column-directional edge value, the pattern corresponds to a diagonal-direction pattern, which may be included arbitrarily in the row-directional pattern or the column-directional pattern.

As such, each pattern of each touch group may be determined by comparing the column-directional edge value and the row-directional edge value.

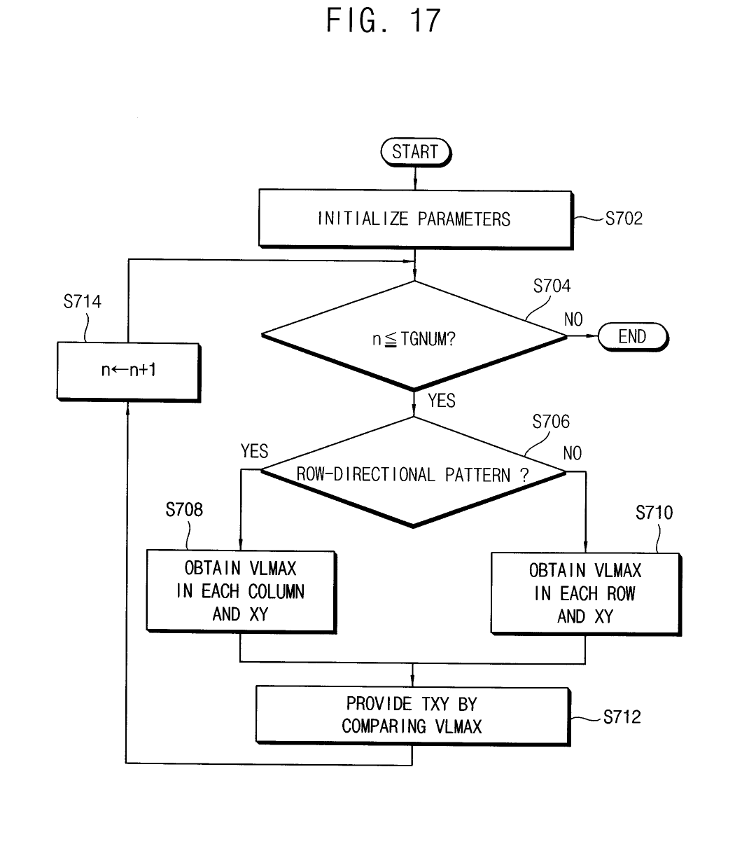

FIG. 17 is a diagram illustrating a method of performing near-touch separation in a touch panel according to exemplary embodiments.

Referring to FIG. 17, parameters for performing near-touch separation are initialized (S702). For example, the touch group serial number n is set to 1 and the touch group number TGNUM is set to a total number of the touch groups determined by the method of FIG. 15.

When the touch group serial number n is equal to or less than the touch group number TGNUM (S704: YES), it is determined whether the pattern of the n-th touch group is the row-directional pattern (S706). When the touch group serial number n is greater than the touch group number TGNUM (S704: NO), the process is completed since near-touch separation is performed with respect to all of the touch groups.

When the pattern of the n-th touch group is the row-directional pattern (S706: YES), the maximum valid touch levels VLMAX in each column of the n-th touch group and candidate coordinates XY of the panel points having the maximum valid touch levels VLMAX are obtained (S708). When the pattern of the n-th touch group is the column-directional pattern (S706: NO), the maximum valid touch levels VLMAX in each row of the n-th touch group and candidate coordinates XY of the panel points having the maximum valid touch levels VLMAX are obtained (S710).

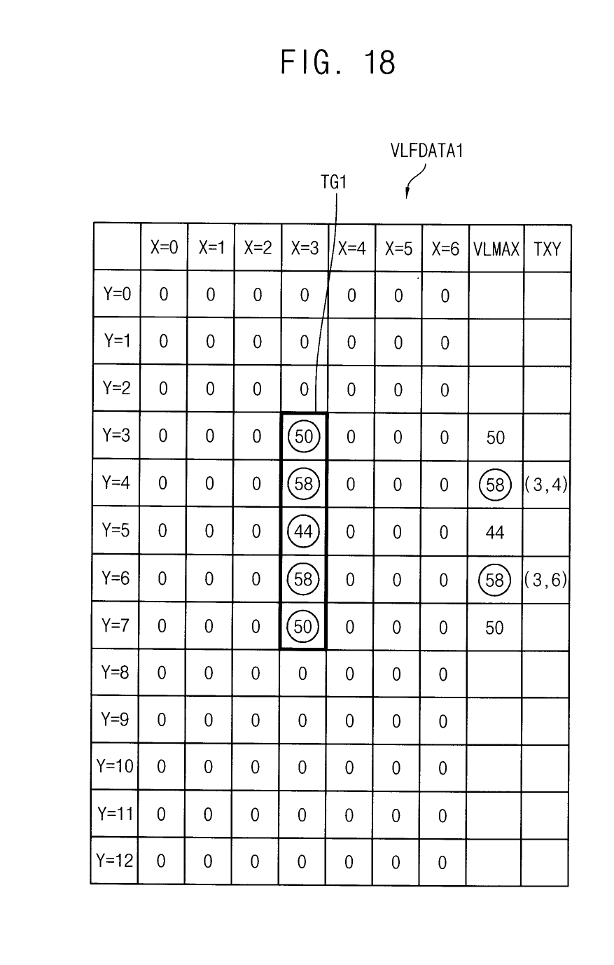

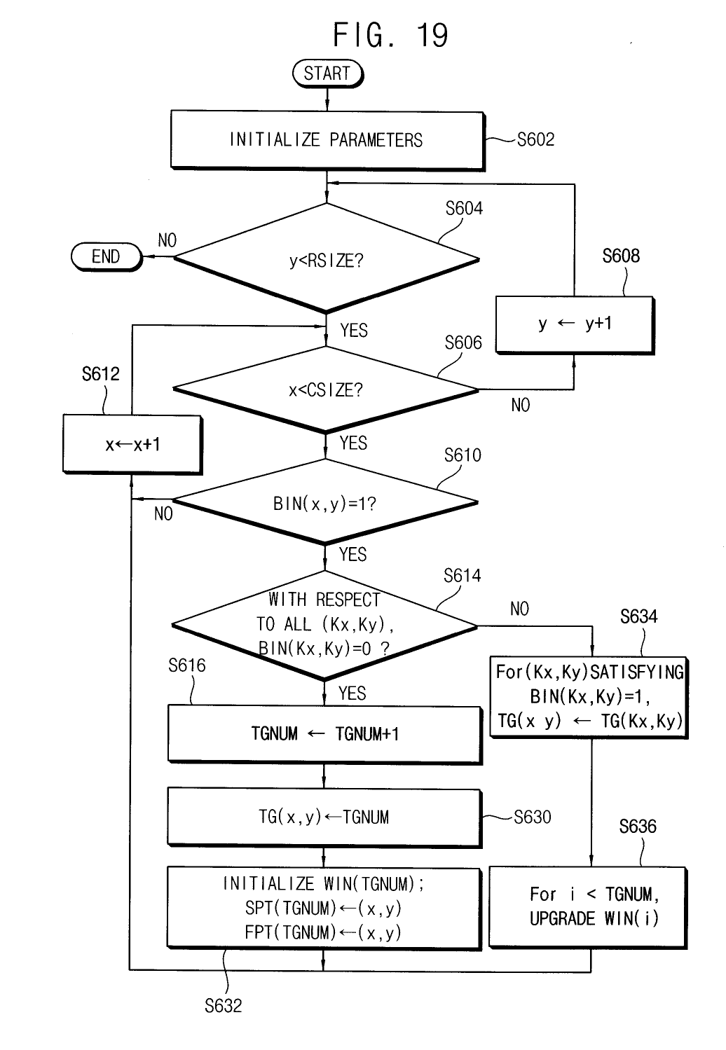

The maximum valid touch levels VLMAX are compared with each other to determine the coordinates TXY of the touch points among the candidate coordinates XY (S712), which will be further described with reference to FIG. 18. After the coordinates TXY of the touch points in the n-th touch group are provided (S712), the touch group serial number n is increased by 1 (S714) and then the touch group serial number n is compared with the touch group number TGNUM (S704).

Determining the pattern of the touch group first and then obtaining the maximum valid touch levels VLMAX in each column or in each row of the touch group corresponds to generation of the two-dimensional edge map. Through such two-dimensional edge map, a plurality of near touch points, which may exist in one touch group, may be separated effectually.

FIG. 18 is a diagram for describing an example of providing coordinates of touch points in the method of FIG. 17.

FIG. 18 illustrates the valid frame data VLFDATA1 including one touch group TG1 of the column-directional pattern. Obtaining the maximum valid touch levels VLMAX in each row and the candidate coordinate XY (S710) and providing the coordinates TXY of the touch points (S712) are described with reference to FIG. 18. It will be understood that, in case of the row-directional pattern, the maximum valid touch levels VLMAX in each column and the candidate coordinate XY may be obtained (S708) and the coordinates TXY of the touch points may be provided (S712).

Referring to FIG. 18, since the touch group TG1 has the column-directional pattern, the maximum valid touch levels VLMAX in each row (that is, y=3, 4, 5, 6 and 7) are obtained and the corresponding candidate coordinates XY are obtained. The touch group TG1 includes one column (x=3) and thus the valid touch level itself is the maximum touch level in the corresponding row. That is, the maximum valid touch levels VLMAX(x, y) with respect to the candidate coordinates XY=(x, y) are obtained as VLMAX(3, 3)=50, VLMAX(3, 4)=58, VLMAX(3, 5)=44, VLMAX(3, 6)=58 and VLMAX(3, 7)=50. Comparing the maximum touch levels, VLMAX(3, 4)=58 is a peak maximum value compared with the maximum valid touch levels VLMAX(3, 3)=50 and VLMAX(3, 5)=44 of the adjacent rows and thus (3, 4) is determined as the touch point TXY1. Also VLMAX(3, 6)=58 is a peak maximum value compared with the maximum valid touch levels VLMAX(3, 5)=44 and VLMAX(3, 7)=50 of the adjacent rows and thus (3, 6) is determined as the touch point TXY2. As a result, two near touch points are determined in the touch group TG1 and the coordinates of the touch points are provided as TXY1=(3, 4) and TXY2=(3, 6).

As such, the touch points in each touch group may be separated based on each pattern of each touch group and the coordinates TXY of the touch points may be provided.

FIG. 19 is a diagram illustrating an example of scanning a binary map to determine touch groups in the method of FIG. 10.

FIG. 19 illustrates determining the touch groups according to the scanning method and the kernel of FIG. 13A. Compared with the method of FIG. 15, the method of FIG. 19 further includes determining each window WIN representing a position and a size of each touch group.

Referring to FIG. 19, parameters for scanning a binary map to determine one or more touch groups are initialized (S602). For example, a start point is set to (0, 0) by initializing the column coordinate x and the row coordinate y. The row size RSIZE and the column size CSIZE are set to the column number and the row number of the touch panel. A touch group number TGNUM is set to 0. With respect to all points (x, y), touch group serial number TG(x, y) is set to 0.

When the row coordinate y is less than the row size RSIZE (S604: YES), the column coordinate x is compared with the column size CSIZE (S606). When the row coordinate y is not less than the row size RSIZE (S604: NO), the determination of the touch groups is finished since scanning is performed with respect to all panel points.

When the column coordinate x is less than the column size CSIZE (S606: YES), the binary value BIN(x, y) of the current source point (x, y) is compared with the first value, that is, 1 (S610). When the column coordinate x is not less than the column size CSIZE (S606: NO), the row coordinate y is increased by 1 (S608) since scanning one row is finished, and the row coordinate y is compared with the row size RSIZE (S604).

When the binary value BIN(x, y) of the source point (x, y) is 1 (that is, the first value) (S610: YES), it is determined whether the binary value BIN(Kx, Ky) is 0 (that is, the second value) with respect to all kernel points (Kx, Ky) (S614). For example, the kernel points (Kx, Ky) may be set to a=(x−1, y−1), b=(x, y−1), c=(x+1, y−1) and d=(x−1, y) with respect to each source point (x, y) as described above with reference to FIG. 13A. When the binary value BIN(x, y) of the source point (x, y) is 0 (that is, the second value) (S610: NO), the column coordinate x is increased by 1 (S612) and then the column coordinate x is compared with the column size CSIZE (S606).

When the binary value BIN(Kx, Ky) is 0 with respect to all kernel points (Kx, Ky) (S614: YES), which indicates that a new touch group is detected, the touch group number TGNUM is increased by 1 (S616), and then the touch group number TGNUM is assigned to the touch group serial number TG(x, y) (S630) of the current source point (x, y) as represented by TG(x, y)=TGNUM. In this way, it may be represented that the current source point (x, y) belongs to the TGNUM-th touch group. In addition, the touch window WIN(TGNUM) of the TGNUM-th touch group is initialized (S632). For example, the touch window WIN may be represented by a minimum column coordinate, a minimum row coordinate, a maximum column coordinate and a maximum row coordinate of the panel points in the corresponding touch group. In other words, the touch window WIN(TGNUM) of the TGNUM-th touch group may be represented by coordinates of a window star point SPT(TGNUM) and a window end point FPT(TGNUM). When the binary value BIN(x, y) of the current source point (x, y) is 1 (S610: YES) and the binary value BIN(Kx, Ky) is 0 with respect to all kernel points (Kx, Ky) (S614: YES), the current source point (x, y) belongs to a new touch group. In this case, the touch window WIN(TGNUM) may be initialized by setting the window start point SPT(TGNUM) and the window end point FPT(TGNUM) (S630) to the current sour point (x, y). The column coordinate x is increased by 1 (S612) and the column coordinate x is compared with the column size CSIZE (S606).

When the binary value BIN(Kx, Ky) is not 0 with respect to all kernel points (Kx, Ky) (S614: NO), the touch group serial number TG(Kx, Ky) of the kernel point satisfying BIN(Kx, Ky)=1 is assigned to the touch group serial number TG(x, y) of the current source point (x, y) (S634) as represented by TG(x, y)=TG(Kx, Ky). In this way, it may be represented that the current source point (x, y) and the kernel point (Kx, Ky) satisfying BIN(Kx, Ky)=1 belong to the same touch group. In addition, when i (i<TGNUM) is the touch group serial number TG(Kx, Ky) of the kernel point satisfying BIN(Kx, Ky)=1, the touch window WIN(i) of the i-th touch group is upgraded (636). In other words, the window start point SPT(i) and the window end point FPT(i) of the touch window WIN(i) of the i-th touch group are upgraded to include the current source point (x, y).

In this case (S614: NO), since a new touch is not detected, without increasing the touch group number TGNUM, the column coordinate x is increased by 1 (S612) and the column coordinate x is compared with the column size CSIZE (5606).

As a result, the touch group serial number TG(x, y) is assigned for all panel points (x, y) of the touch panel, and the number of the detected touch groups corresponds to the finally determined TGNUM. In addition, the touch windows are determined to represent the positions and the sizes of the respective touch groups.

For example, when the touch window WIN(i) of the i-th touch group TGi is determined to have the window start point SPT(i)=(x1, y1) and the window end point FPT(i)=(x2, y2), the column-directional length of the i-th touch group may be calculated as y2−y1+1, and the row-directional length of the i-th touch group may be calculated as x2−x1+1. In exemplary embodiments, each pattern of each touch group may be determined by comparing the column-directional length y2−y1+1 and the row-directional length x2−x1+1 of each touch group. The pattern of the touch group may be determined to the column-directional pattern when the column-directional length y2−y1+1 is greater than the row-directional length x2−x1+1, and pattern of the touch group may be determined to the row-directional pattern when the column-directional length y2−y1+1 is less than the row-directional length x2−x1+1. When the column-directional length y2−y1+1 is equal to the row-directional length x2−x1+1, the pattern of the touch group corresponds to a diagonal-direction pattern, which may be included in the row-directional pattern or the column-directional pattern.

In exemplary embodiments, a touch unintended by a user may be detected based on at least one of the row-directional length x2−x1+1 and the column-directional length y2−y1+1 of each touch group. When at least one of the row-directional length x2−x1+1 and the column-directional length y2−y1+1 is greater than a reference length, the touch corresponding to the touch group may be considered as the unintended touch. For example, if the user contacts a palm on the touch panel, it may be considered as a meaningless input action. Invalidating such unintended touch is referred to as palm rejection. The reference length for determining the palm rejection may be set to an appropriate value considering resolution of the touch panel, etc. The reference length may be set experimentally. The palm rejection may be performed when one of the row-directional length x2−x1+1 and the column-directional length y2−y1+1 is greater than the reference length or when both of the row-directional length x2−x1+1 and the column-directional length y2−y1+1 are greater than the reference length. The reference length may be set to the same value or different values with respect to the row direction and the column direction.

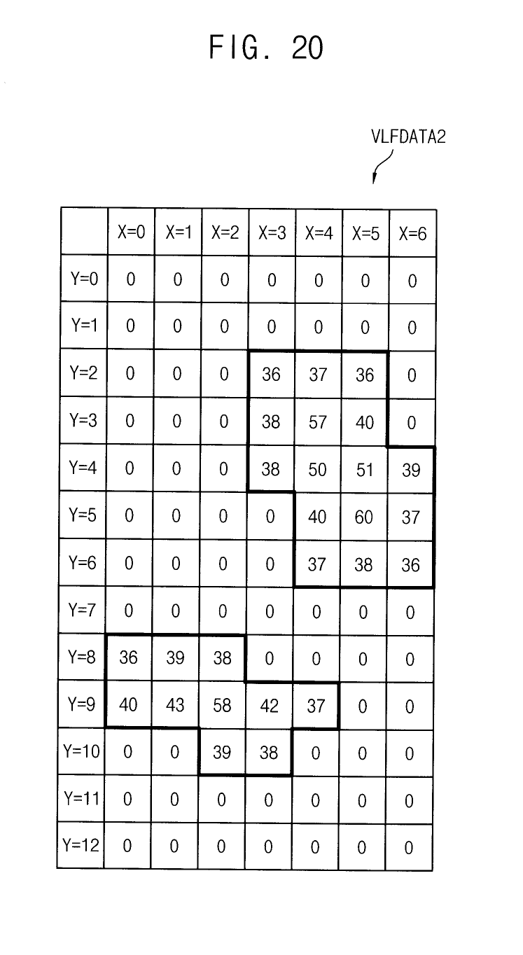

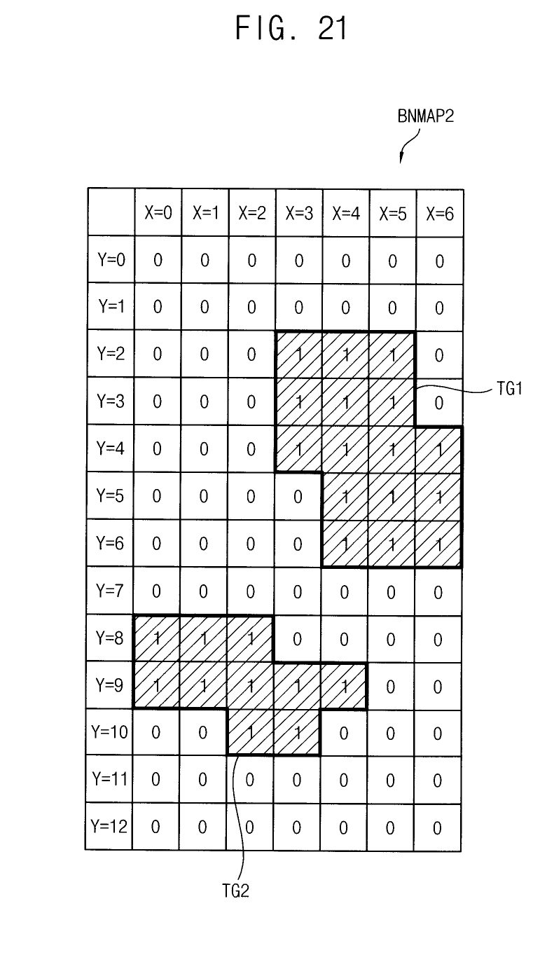

FIG. 20 is a diagram illustrating valid frame data determined from an input frame provided from the touch panel of FIG. 2, and FIG. 21 is a diagram illustrating a binary map corresponding to the valid frame data of FIG. 20.

Referring to FIG. 20, it may be understood intuitively that a valid frame data VLFDATA2 includes two touch groups. Even though an input frame data is not illustrated, it may be understood that the valid frame data VLFDATA2 of FIG. 20 may be determined from the corresponding input frame data by removing noise touch levels among the input touch levels adaptively depending on a distribution of the input touch levels as described above.

Referring to FIG. 21, a binary map BNMAP2 may be generated by assigning 1 (that is, a first value) to the 16 panel points having the valid touch levels to form a first touch group TG1, by assigning 1 to the 10 panel points having the valid touch levels to form a second touch group TG2 and by assigning 0 (that is, a second value) to the 65 panel points having the noise touch levels.

As described above with reference to FIGS. 15 and 19, one or more touch groups TG1 and TG2 may be determined by scanning the binary map BNMAP2, such that each touch group corresponds to the panel points that have the valid touch levels and are adjacent from each other in the touch panel. That is, the total number of the touch groups is determined and the touch group serial number TG(x, y) is imposed with respect to all panel points (x, y) by the methods of FIGS. 15 and 19. In cased of the binary map BNMAP2, the touch group serial number TG(x, y)=1 is imposed to the 16 panel points in the first touch group TG1, the touch group serial number TG(x, y)=2 is imposed to the 10 panel points in the second touch group TG2, and the total number of the touch groups is determined as 2.

In addition, as described with reference to FIG. 19, each touch window WIN representing the position and the size of each touch group may be further determined. The touch window WIN may be represented by a minimum column coordinate, a minimum row coordinate, a maximum column coordinate and a maximum row coordinate of the panel points in the corresponding touch group. In other words, the touch window WINi of the i-th touch group may be represented by coordinates of a window star point SPTi and a window end point FPTi.

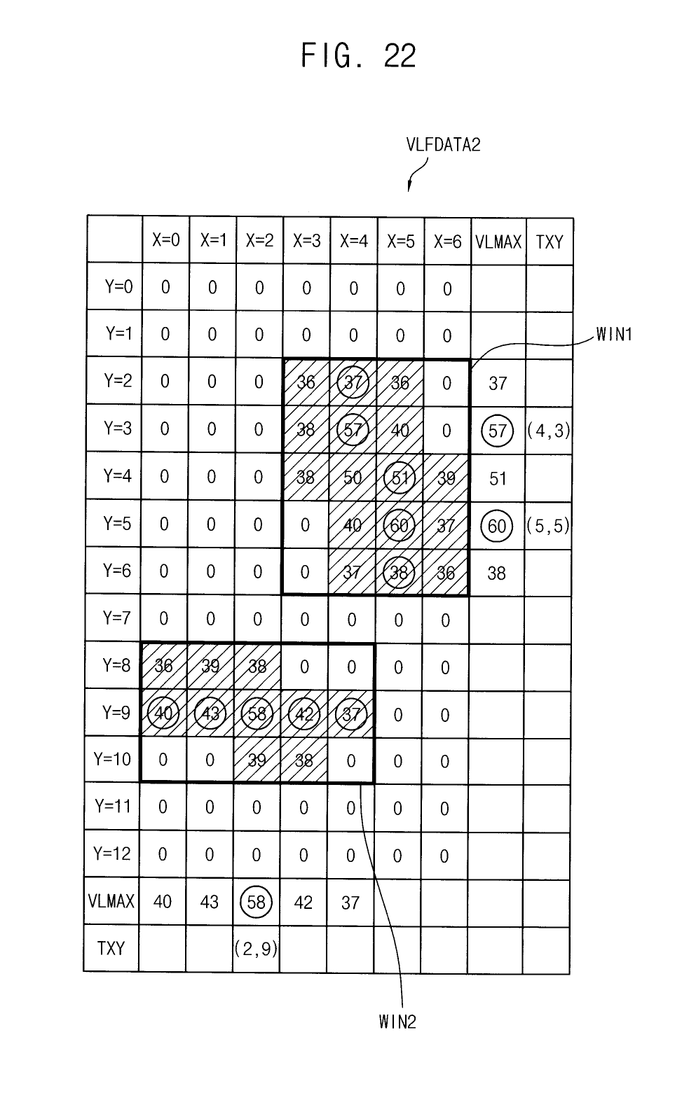

FIG. 22 is a diagram for describing an example of providing coordinates of touch points in the method of FIG. 17.

In FIG. 22, the portions filled with slash lines represent the touch groups TG1 and TG2, and the rectangular portions surrounded by the bolded lines represent the touch windows WIN1 and WIN2.

The first touch window WIN1 may be represented by the window start point SPT1=(3, 2) and the window end point FPT1=(6, 6), and the second touch window WIN2 may be represented by the window start point SPT2=(0, 8) and the window end point FPT2=(4, 10).

In some exemplary embodiments, each pattern of each touch group may be determined by comparing the column-directional edge value and the row-directional edge value of each touch group as described above with reference to FIG. 16.

In other exemplary embodiments, each pattern of each touch group may be determined by comparing the row-directional length and the column-directional length of each touch group as described above with reference to FIG. 19. The pattern of the first touch group TG1 is determined as the column-directional pattern since the row-directional length (that is, x2−x1+1=4) is less than the column directional length (that is, y2−y1+1=5). The pattern of the second touch group TG2 is determined as the row-directional pattern since the row-directional length (that is, x2−x1+1=5) is greater than the column directional length (that is, y2−y1+1=3).

After each pattern of each touch group is determined, the coordinates of the touch points may be provided by performing near-touch separation based on the determined pattern as described above with reference to FIG. 17.

Referring FIGS. 17 and 22, since the first touch group TG1 has the column-directional pattern (S706: NO), the maximum valid touch levels VLMAX in each row of the first touch group TG1 and candidate coordinates XY of the panel points having the maximum valid touch levels VLMAX are obtained (S710). That is, the relation between the maximum valid touch level VLMAX(x, y) and the corresponding candidate coordinates (x, y) may represented by VLMAX(4, 2)=37, VLMAX(4, 3)=57, VLMAX(5, 4)=51, VLMAX(5, 5)=60 and VLMAX(5, 6)=38. Comparing the maximum touch levels, VLMAX(4, 3)=57 is a peak maximum value compared with the maximum valid touch levels VLMAX(4, 2)=37 and VLMAX(5, 4)=51 of the adjacent rows and thus (4, 3) is determined as the first touch point TXY1. Also VLMAX(5, 5)=60 is a peak maximum value compared with the maximum valid touch levels VLMAX(5, 4)=51 and VLMAX(5, 6)=38 of the adjacent rows and thus (5, 5) is determined as the second touch point TXY2.

Since the second touch group TG2 has the row-directional pattern (S706: YES), the maximum valid touch levels VLMAX in each column of the second touch group TG2 and candidate coordinates XY of the panel points having the maximum valid touch levels VLMAX are obtained (S708). That is, the relation between the maximum valid touch level VLMAX(x, y) and the corresponding candidate coordinates (x, y) may represented by VLMAX(0, 9)=40, VLMAX(1, 9)=43, VLMAX(2, 9)=58, VLMAX(3, 9)=42 and VLMAX(4, 9)=37. Comparing the maximum touch levels, VLMAX(2, 9)=58 is a peak maximum value compared with the maximum valid touch levels VLMAX(1, 9)=43 and VLMAX(3, 9)=42 of the adjacent columns and thus (2, 9) is determined as the third touch point TXY3.

As a result, the first and second touch points TXY1 and TXY2 disposed near in the first touch group TG1 may be separated and the coordinates of the three touch points TXY1, TXY2 and TXY3 may be provided.

As such, according to the exemplary embodiments, fine detection of multi-touch may be performed by separating the touch points disposed relatively farther through determination of the touch groups and then by performing near-touch separation in each touch group.

FIG. 23 is a block diagram illustrating a touch screen device according to exemplary embodiments.

Referring to FIG. 23, a touch screen device 3000 may include a touch panel 10, a display panel 20, a touch panel controller 30, a display driver 40, a processor 50, a storage 60, an interface 70 and a bus 80.

The touch panel 10 may include a plurality of panel points that are arranged in a matrix of a plurality of columns and a plurality of rows. Each position of the panel points on the touch panel may be designated by two-dimensional coordinates (x, y) where x indicates a column coordinate and y indicates a row coordinate. The touch panel 10 may be configured to sense a plurality of touches performed by contacts on a plurality of panel points substantially at the same time. In other words, the touch panel 10 may be configured to output a set of input touch levels IN representing contact intensity or touch intensity on the respective panel points. The set of the input touch levels IN may be referred to as an input frame data and the input frame data may be provided per a predetermined sensing period, that is, a frame period.

The touch panel controller 30 may control the operation of the touch panel 10 and provides outputs of the touch panel 10 to the processor 50. When the touch panel 10 outputs analog signals, the touch panel controller 30 may include an analog-to-digital converter to convert the analog signals to the digital signals.

The display panel 20 may be implemented with various panels such as liquid crystal display (LCD), light emitting diode (LED), organic LED (OLED), etc. The display driver 40 may include a gate driving unit, a source driving unit, etc. to display images on the display panel 20. The processor 50 may be configured to control overall operations of the touch screen device 3000. Program codes and data accessed by the processor 50 may be stored in the storage 60. The interface 70 may have appropriate configuration according to external devices and/or systems communicating with the touch screen device 3000.

In some exemplary embodiments, at least a portion of the multi-touch detector 300 described with reference to FIGS. 2 and 3 may be implemented as hardware and may be included in the touch panel controller 30. In other exemplary embodiments, at least a portion of the multi-touch detector 300 may be implemented as software and may be stored in the storage 60 in a form of program codes that may be executed by the processor 50.

As described with reference to FIG. 3, the multi-touch detector 300 may include a noise remover 310, a touch group detection unit 330, a pattern decision unit 350 and a refine touch detection unit 370. The noise remover 310 removes noise touch levels among the input touch levels IN adaptively depending on a distribution of the input touch levels IN. For example, the noise remover 310 may determine a noise reference level NL based on the distribution of the input touch levels IN, and may remove each input touch level IN as a noise touch level or retain each input touch level IN as a valid touch level based on the determined noise reference level.

The touch group detection unit 330 may determine one or more touch groups, such that each touch group corresponds to the panel points that have the valid touch levels and are adjacent from each other in the touch panel 100. In an exemplary embodiment, the noise remover 310 may provide a binary map in addition to the valid touch levels excluding noises. In this case, the touch group detection unit 330 may determine the touch groups by scanning the binary map.

The pattern decision unit 350 may determine each pattern of each touch group among a row-directional pattern and a column-directional pattern. The row-directional pattern may represent that multiple touches in the touch group are arranged in a row-direction and the column-directional pattern may represent that multiple touches in the touch group are arranged in a column-direction. The refine touch detection unit 370 may separate the touch points in each touch group based on each pattern of each touch group to provide coordinates of the touch points. The multiple touches in a single touch group may be referred to as near-touch, and the refine touch detection unit 370 may perform near-touch separation for detecting such near-touch to determine one or more touch points in the single touch group.

As such, the input touch action of variable touch intensity by the user may be detected effectually by removing the noises adaptively based on the distribution of the input touch levels. In addition, fine detection of multi-touch may be performed by separating the touch points disposed relatively farther through determination of the touch groups and then by performing near-touch separation in each touch group.

In some exemplary embodiments, the coordinate mapper 500 described with reference to FIG. 2 may be implemented as software and may be stored in the storage 60 in a form of program codes that may be executed by the processor 50. In other exemplary embodiments, the coordinate mapper 500 may be implemented as hardware and may be included in the touch panel controller 30. The coordinate mapper 500 may extract mapped coordinates DXY of touch pixels in the display panel 20, where the touch pixels in the display panel 20 correspond to the touch points in the touch panel 10. The extraction of mapped coordinates will be further described with reference to FIGS. 25, 26, 27 and 28.

The processor 50 may perform various calculations or tasks. According to exemplary embodiments, the processor 50 may be a microprocessor or a central processing unit (CPU). The processor 50 may communicate with the storage 60 via the bus 80, and may communicate with an external host through the interface 70 coupled to the bus 80. The bus 80 may include an extended bus, such as a peripheral component interconnection (PCI) bus.

The storage 60 may store data for operating the touch screen device 3000. For example, the storage 60 may be implemented with a dynamic random access memory (DRAM) device, a mobile DRAM device, a static random access memory (SRAM) device, a phase random access memory (PRAM) device, a ferroelectric random access memory (FRAM) device, a resistive random access memory (RRAM) device, and/or a magnetic random access memory (MRAM) device. Furthermore, the storage 60 may include a solid state drive (SSD), a hard disk drive (HDD), a CD-ROM, etc. The touch screen device 3000 may further include an input device such as a keyboard, a keypad, a mouse, etc. and an output device such as a printer, etc.

The touch screen device 3000 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

The touch screen device 3000 may be various devices that include a touch screen in which the touch panel 10 and the display panel 20 are formed in one panel. For example, the touch screen device 3000 may include a digital camera, a mobile phone, a personal digital assistant (PDA), a portable multimedia player (PMP), a smart phone, a tablet computer, etc.

The interface 70 may include a radio frequency (RF) chip for performing a wireless communication with an external host. A physical layer (PHY) of the external host and a physical layer (PHY) of the RF chip may perform data communications based on a MIPI DigRF. In addition, the interface 70 may be configured to perform communications using an ultra wideband (UWB), a wireless local area network (WLAN), a worldwide interoperability for microwave access (WIMAX), etc. The touch screen device 300 may further include a global positioning system (GPS), a MIC, a speaker, etc.

FIG. 24 illustrates an example of multi-touch performed in a touch screen.

Referring to FIG. 24, the touch panel 10 and the display panel 20 may be superimposed to form the touch screen. That is, the position on the touch panel 10 and the position on the display panel 20 may be mapped to each other. Through such mapping of the positions or coordinates, the user may perform input actions including a single-touch action for selecting an icon or a menu item displayed on the touch screen and a multi-touch action such as a drag, a pinch, a stretch, etc.

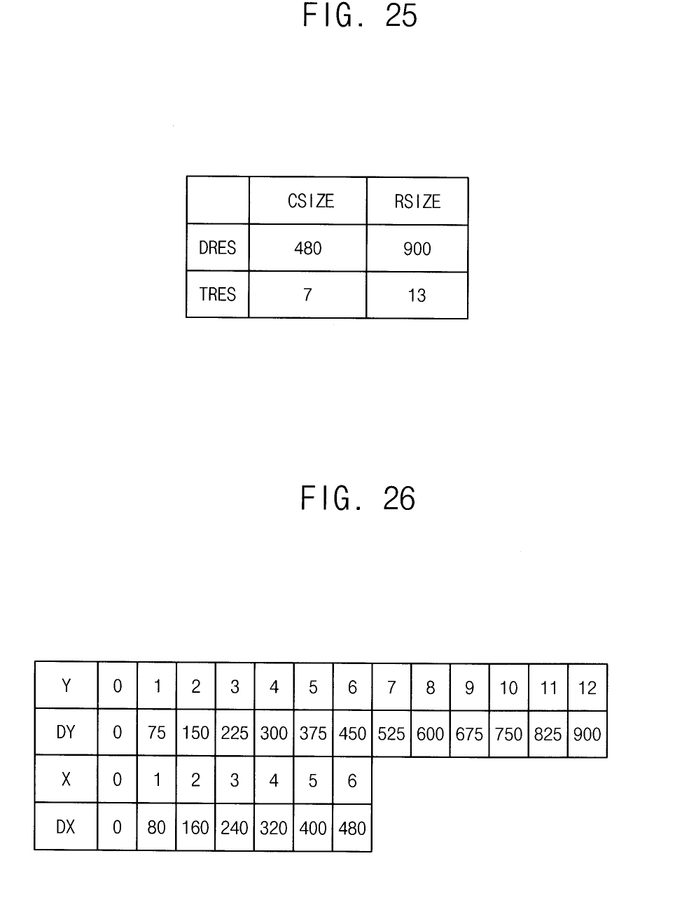

FIG. 25 is a diagram illustrating an example of a touch panel resolution and a display panel resolution, and FIG. 26 is a diagram illustrating an example mapping relation between coordinates of a touch panel and coordinates of a display panel.

In FIG. 25, RSIZE represents a row number and CSIZE represents a column number. In general, the touch panel resolution TRES is relatively low since input of the touch panel is performed using fingers or stylus pens. The touch panel resolution TRES of FIG. 25 indicates that the touch panel includes the panel points arranged in 7 columns and 13 rows.

The display panel resolution DRES tends to be increased to provide an image of high quality, and display panel resolution DRES is higher than the touch panel resolution TRES in the typical touch screen. The display panel resolution DRES of FIG. 25 indicates that the display panel includes the pixels arranged in 480 columns and 900 rows.

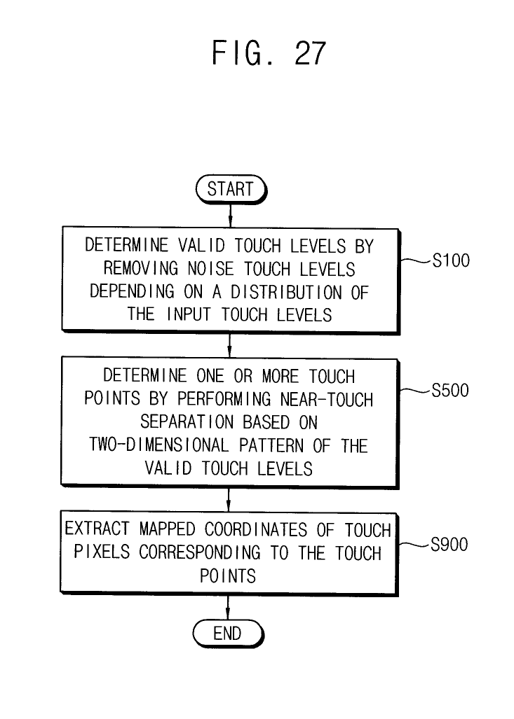

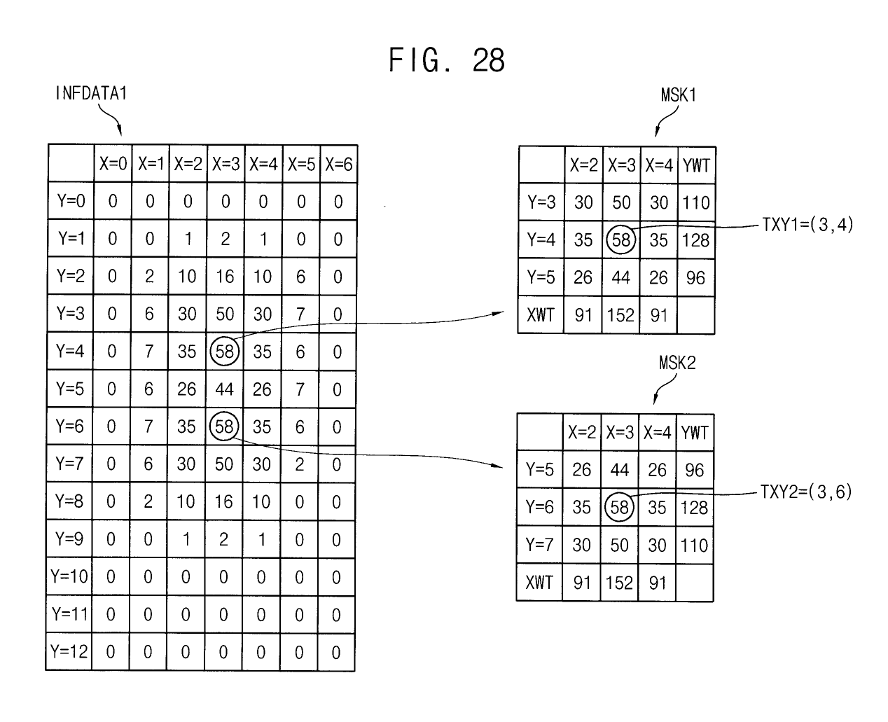

FIG. 26 illustrates the mapping relation between the coordinates (X, Y) of the touch panel and the coordinates (DX, DY) of the display panel corresponding to the example of FIG. 25. Extracting mapped coordinates of touch pixels in the display panel from the coordinates of the touch points in the touch panel will be described with reference to FIGS. 27 and 28.

FIG. 27 is a flowchart illustrating a method of operating a touch screen according to exemplary embodiments.

Referring to FIG. 27, to operate a touch screen including a touch panel and a display panel where the touch panel has a plurality of panel points for sensing respective input touch levels, valid touch levels are determined by removing noise touch levels among the input touch levels adaptively depending on a distribution of the input touch levels (S100). One or more touch points among the panel points are determined by performing near-touch separation based on a two-dimensional pattern of the valid touch levels (S500). Mapped coordinates of touch pixels in the display panel are extracted (S900) where the touch pixels in the display panel correspond to the touch points in the touch panel.

In some exemplary embodiments, a mask may be set such that the mask includes a portion of the panel points centered on each touch point, and the mapped coordinates of the touch pixels may be extracted using the input touch levels of the panel points in the mask as weight values.

FIG. 28 is a diagram for describing an example of extracting mapped coordinates of touch pixels in the method of FIG. 27.

The input frame data INFDATA1 of FIG. 1 is included in the FIG. 28. The first touch point TXY1=(3, 4) and the second touch point TXY2=(3, 6) may be determined by the adaptive noise removal and near-touch separation as described above.

The masks MSK1 and MSK2 are set to include a portion of the panel points centered on the touch points TXY1 and TXY2, respectively. The masks MSK1 and MSK2 may include the panel points arranged in a plurality of rows and a plurality of columns centered on each touch point. For example, each of the masks MSK1 and MSK2 may be extended to include the panel points in 3 rows and 3 columns centered on each of the touch points TXY1 and TXY2 as illustrated in FIG. 28.

The mapped coordinates of the touch pixels in the display panel may be extracted using the input touch levels of the panel points in the mask as weight values.

For example, the mapped column coordinate DX of the touch pixel DXY=(DX, DY) corresponding to the column coordinate X of the touch point TXY=(X, Y) may be extracted using Expressions 9 and 10.

$$\begin{matrix}XWTi = {\sum }_{i}^{mask} IN ( i , j ) & ( Expression 9 ) \\ DX = \frac{{\sum }_{i}^{mask} [ XWTi \times DXi ]}{{\sum }_{i}^{mask} XWTi} & ( Expression 10 )\end{matrix}$$

In Expressions 9 and 10, the summation notation denotes the sum in the mask, IN(i, j) denotes the input touch level of the panel point (i, j). DXi denotes the column coordinate of the display panel corresponding to the column coordinate Xi of the touch panel. The mapping relation between DXi and Xi may be determined according to resolutions of the panels as illustrated in FIGS. 25 and 26.

The weight values XWT are obtained using Expression 9 such that each weight value XWTi corresponds to a sum of the input touch levels in each column of the mask, and then the mapped column coordinate DX may be obtained using the mapping relation as illustrated in FIG. 26 and Expression 10 indicating a weighted average calculation.

In the same way, the mapped row coordinate DY of the touch pixel DXY=(DX, DY) corresponding to the row coordinate Y of the touch point TXY=(X, Y) may be extracted using Expressions 11 and 12.

$$\begin{matrix}YWTj = {\sum }_{i}^{mask} IN ( i , j ) & ( Expression 11 ) \\ DY = \frac{{\sum }_{i}^{mask} [ YWTj \times DYj ]}{{\sum }_{j}^{mask} YWTj} & ( Expression 12 )\end{matrix}$$

In Expressions 11 and 12, the summation notation denotes the sum in the mask, IN(i, j) denotes the input touch level of the panel point (i, j). DYi denotes the row coordinate of the display panel corresponding to the row coordinate Yi of the touch panel. The mapping relation between DYi and Yi may be determined according to resolutions of the panels as illustrated in FIGS. 25 and 26.

The weight values YWT is obtained using Expression 11 such that each weight value YWTi corresponds to a sum of the input touch levels in each row of the mask, and then the mapped column coordinate DY may be obtained using the mapping relation as illustrated in FIG. 26 and Expression 12 indicating a weighted average calculation.

To obtain the mapped column coordinate DX of the display panel corresponding to the column coordinate X1 of the first touch point TXY1 in the touch panel, the weight values XTWi are obtained first using Expression 9. The first mask MSK1 includes three columns (that is, i=2, 3, 4) and three rows (that is, j=3, 4, 5), and it is calculated that XWT2=91, XWT3=152 and XWT4=91 as illustrated in FIG. 28. Using Expression 10 and the mapping relation of FIG. 26, in which X=2 is mapped to DX2=160, X=3 is mapped to DX3=240 and X=4 is mapped to DX4=320, the DX is obtained as DX=(91*160+152*240+91*320)/(91+152+91)=80160/334=240.

In the same way, to obtain the mapped row coordinate DY of the display panel corresponding to the row coordinate Y1 of the first touch point TXY1 in the touch panel, the weight values YTWi are obtained first using Expression 11. The first mask MSK1 includes three columns (that is, i=2, 3, 4) and three rows (that is, j=3, 4, 5), and it is calculated that YWT3=110, YWT4=128 and YWT5=96 as illustrated in FIG. 28. Using Expression 12 and the mapping relation of FIG. 26, in which Y=3 is mapped to DY3=225, Y=4 is mapped to DY4=300 and Y=5 is mapped to DY5=375, the DY is obtained as DY=(110*225+128*300+96*375)/(110+128+96)=99150/334=297.

In summary, the mapped coordinates DXY1 of the display panel corresponding to the coordinates TXY1=(3, 4) of the first touch point are extracted as DXY1=(240, 297).

In the same way, the mapped coordinates DXY2 of the display panel corresponding to the coordinates TXY2=(3, 6) of the second touch point are extracted as DXY2=(240, 455).

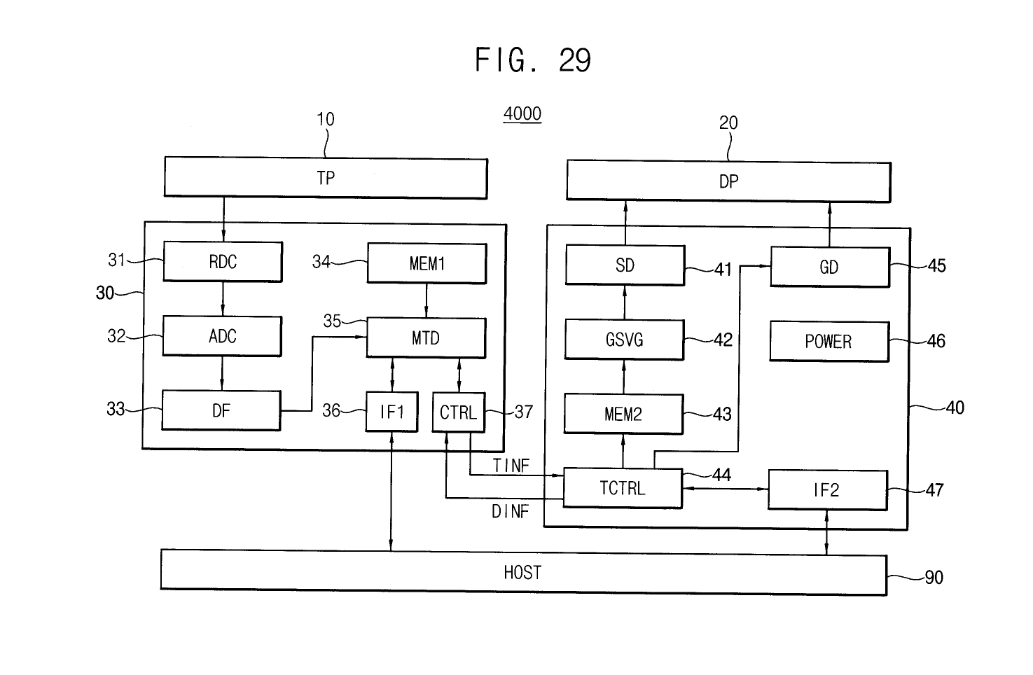

FIG. 29 is a block diagram illustrating a touch screen device according to exemplary embodiments.

Referring to FIG. 29, a touch screen device 4000 may include a touch panel (TP) 10, a display panel (DP) 20, a touch panel controller 30 and a display driver 40. The touch screen device 4000 may be coupled to en external host 90.

As described with reference to FIG. 24, the touch panel 10 and the display panel 20 may be superimposed to form a touch screen. That is, the position on the touch panel 10 and the position on the display panel 20 may be mapped to each other. Through such mapping of the positions or coordinates, the user may perform input actions including a single-touch action for selecting an icon or a menu item displayed on the touch screen and a multi-touch action such as a drag, a pinch, a stretch, etc.

According to exemplary embodiments, the touch panel controller 30 may include a multi-touch detector (MTD) 35 that is configured to determine valid touch levels by removing noise touch levels among the input touch levels adaptively depending on a distribution of the input touch levels and configured to determine one or more touch points among the panel points having the valid touch levels by performing near-touch separation based on a two-dimensional pattern of the valid touch levels. The multi-touch detector 35 may provide the coordinates of the detected touch points or the mapped coordinates of the pixels in the display panel 20 corresponding to the touch points in the touch panel 10 according to whether the multi-touch detector 35 includes a coordinate mapper or not.

As mentioned above, at least a portion of the multi-touch detector 35 may be implemented as hardware in some exemplary embodiments. Alternatively the method of detecting multi-touch according to exemplary embodiments may be implemented as program codes that are stored in a memory device (MEM1) 34.

The touch panel controller 30 may further include a readout circuit (RDC) 31 an analog-to-digital converter (ADC) 32, a filter (DF) 33, a memory device (MEM1) 34, an interface (IF1) 36 and a control logic (CTRL) 37. The readout circuit 31 may output the touch data sensed by the touch panel 10 as analog signals, the analog-to-digital converter 32 may convert the analog signals to digital signals. The digital signals are filtered by the digital filter 33 and the filtered signals are provided to the multi-touch detector 35 as the input touch levels as described above. The multi-touch detector 35 may provide the coordinates of the touch points in the touch panel 10 or the mapped coordinates of the corresponding pixels in the display panel 20 to the host 90 through the interface 36. The control logic 37 may control overall operations of the touch panel controller 30.

The display driver 40 controls the display panel 20 to display an image thereon. The display driver 40 may include a source driver (SD) 41, a gray-scale voltage generator (GSVG) 42, a memory device (MEM2) 43, a timing controller (TCTRL) 44, a gate driver (GD) 45, a power supplier (POWER) 46 and an interface 47. Image data to be displayed on the display panel 20 may be provided from the host 90 through the interface 47 and may be stored in the memory device 43. The image data may be converted to appropriate analog signals based on gray-scale voltages from the gray-scale voltage generator 42. The source driver 41 and the gate driver 45 may drive the display panel 20 in synchronization with signals from the timing controller 44.

In exemplary embodiments, the control logic 37 of the touch panel controller 30 may provide touch information TINF representing the operational state of the touch panel 10 to the display driver 40 and/or may receive display information DINF representing the operational timing of the display panel 20 from the timing controller 44. For example, the touch information TINF may include an idle signal that is activated when the touch input action is not performed for a predetermined time. In this case, the display driver 40 may enter a power-down mode in response to the idle signal. The display information DINF may include a timing signal such as a horizontal synchronization signal and/or a vertical synchronization signal, and the operation timing of the touch panel 10 may be controlled based on the timing signal.

Methods according to exemplary embodiments may be applicable to various devices and systems including a touch panel, and particularly to devices and systems including a touch screen in which a touch panel and a display panel are superimposed to form the touch screen.

The foregoing is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A method of detecting multi-touch in a touch panel including a plurality of panel points for sensing respective input touch levels, the method comprising:
determining valid touch levels by adaptively removing noise touch levels among the input touch levels based on a distribution of the input touch levels; and
determining one or more touch points among the panel points having the valid touch levels by performing near-touch separation based on a two-dimensional pattern of the valid touch levels.

2. The method of claim 1, wherein the determining the valid touch levels comprises:
adaptively determining a noise reference level based on the distribution of the input touch levels;
removing, as the noise touch levels, the input touch levels that are less than the noise reference level; and
retaining, as the valid touch levels, the input touch levels that are equal to or greater than the noise reference level.

3. The method of claim 2, wherein the adaptively determining the noise reference level comprises:
determining a histogram that represents respective numbers of the panel points having the respective input touch levels;
determining a noise distribution of the input touch levels that are less than a threshold touch level and a touch distribution of the input touch levels that are equal to or greater than the threshold touch level, with respect to a plurality of threshold touch levels; and
determining the noise reference level based on the histogram, the noise distribution and the touch distribution.

4. The method of claim 3, wherein the noise reference level is set to the threshold touch level that gives a maximum value of VBC(t)=WN(t)*WT(t)*[MN(t)−MT(t)]2, where t denotes the threshold touch level, WN(t) denotes a noise histogram weight value of the input touch levels that are less than the threshold touch level, MN(t) denotes a noise mean value of the input touch levels that are less than the threshold touch level, WT(t) denotes a touch histogram weight value of the input touch levels that area equal to or greater than the threshold touch level, and MT(t) denotes a touch mean value of the input touch levels that area equal to or greater than the threshold touch level.

5. The method of claim 3, wherein the noise reference level is set to the threshold touch level that gives a minimum value of VWC(t)=WN(t)*VN(t)+WT(t)*VT(t), where t denotes the threshold touch level, WN(t) denotes a noise histogram weight value of the input touch levels that are less than the threshold touch level, VN(t) denotes a noise variance value of the input touch levels that are less than the threshold touch level, WT(t) denotes a touch histogram weight value of the input touch levels that are equal to or greater than the threshold touch level, and VT(t) denotes a touch variance value of the input touch levels that are equal to or greater than the threshold touch level.

6. The method of claim 1, wherein the determining the one or more touch points comprises:
determining one or more touch groups, each touch group corresponding to the panel points that have the valid touch levels and are adjacent to each other in the touch panel;
determining a pattern of each touch group from among a row-directional pattern and a column-directional pattern; and
separating the touch points in each touch group based on the pattern of each touch group to provide coordinates of the touch points.

7. The method of claim 6, wherein the determining the one or more touch groups comprises:
generating a binary map by assigning a first value to the panel points having the valid touch levels and by assigning a second value to the panel points having the noise touch levels; and
scanning the binary map to determine the touch groups.

8. The method of claim 7, wherein the scanning the binary map comprises:
setting a kernel including kernel points adjacent to a source point; and
detecting a new touch group when the source point has the first value and all of the kernel points have the second value.

9. The method of claim 8, wherein the kernel points are set to (x−1, y−1), (x, y−1), (x+1, y−1) and (x−1, y) with respect to the source point (x, y), where x is a column coordinate and y is a row coordinate, and
wherein the binary map is scanned for all of the source points starting from the source point (0, 0) such that the column coordinate x is increased first and the row coordinate y is increased when one row is scanned.

10. The method of claim 6, wherein the determining the pattern of each touch group comprises:
determining a column-directional edge value corresponding to a number of peak maximum values of row-directional sums, each row-directional sum being obtained by adding the valid touch levels of the panel points in each row of each touch group;
determining a row-directional edge value corresponding to a number of peak maximum values of column-directional sums, each column-directional sum being obtained by adding the valid touch levels of the panel points in each column of each touch group; and
comparing the column-directional edge value and the row-directional edge value to determine each pattern of each touch group.

11. The method of claim 6, wherein the determining the pattern of each touch group comprises:
comparing a row-directional length and a column-directional length of each touch group to determine the pattern of each touch group.

12. The method of claim 6, further comprising:
detecting an unintended touch when at least one of a row-directional length and a column-directional length of each touch group is greater than a reference length.

13. The method of claim 6, wherein the separating the touch points in each touch group comprises:
obtaining candidate coordinates of the panel points having maximum valid touch levels in each row or in each column of each touch group depending on the pattern of each touch group; and
comparing the maximum valid touch levels to determine the coordinates of the touch points among the candidate coordinates.

14. A method of operating a touch screen including a touch panel and a display panel, the touch panel including a plurality of panel points for sensing respective input touch levels, the method comprising:
determining valid touch levels by adaptively removing noise touch levels among the input touch levels based on a distribution of the input touch levels;
determining one or more touch points among the panel points by performing near-touch separation based on a two-dimensional pattern of the valid touch levels; and
extracting mapped coordinates of touch pixels in the display panel, the touch pixels in the display panel corresponding to the touch points in the touch panel.

15. The method of claim 14, wherein the extracting the mapped coordinates of the touch pixels comprises:
setting a mask including a portion of the panel points centered on each touch point; and
calculating the mapped coordinates of the touch pixels using the input touch levels of the panel points in the mask as weight values.

16. The method of claim 15, wherein the mask includes the panel points arranged in a plurality of rows and a plurality of columns centered on each touch point.

17. A method of performing near-touch separation in a touch panel including a plurality of panel points for sensing respective input touch levels, the method comprising:
determining one or more touch groups based on valid touch levels among the input touch levels, each touch group corresponding to the panel points that have valid touch levels and are adjacent in the touch panel;
determining a pattern of each touch group from among a row-directional pattern and a column-directional pattern; and
separating the touch points in each touch group based on the pattern of each touch group to provide coordinates of the touch points.

18. The method of claim 17, wherein the separating the touch points in each touch group comprises:
obtaining candidate coordinates of the panel points having maximum valid touch levels in each row or in each column of each touch group depending on the pattern of each touch group; and
comparing the maximum valid touch levels to determine the coordinates of the touch points among the candidate coordinates.

19. The method of claim 17, further comprising:
adaptively determining a noise reference level based on the distribution of the input touch levels;
removing, as noise touch levels, the input touch levels that are less than the noise reference level; and
retaining, as the valid touch levels, the input touch levels that are equal to or greater than the noise reference level.

20. A device comprising:
a touch screen including a touch panel and a display panel, the touch panel including a plurality of panel points for sensing respective input touch levels;
a touch panel control unit configured to determine valid touch levels by adaptively removing noise touch levels among the input touch levels based on a distribution of the input touch levels, and configured to determine one or more touch points among the panel points by performing near-touch separation based on a two-dimensional pattern of the valid touch levels; and
a display driver configured to control the display panel to display an image on the display panel.

21. A method of detecting multi-touch in a touch panel, the method comprising:
sensing a plurality of input touch levels at a plurality of panel points of the touch panel;
removing noise touch levels from among the plurality of input touch levels using a distribution over the touch panel of the input touch levels;
generating a binary map of the input touch levels that remain after removing the noise touch levels;
detecting a touch group using the binary map; and
detecting at least one two-dimensional pattern within the touch group.

22. The method of claim 21, wherein the detecting the touch group comprises:
setting, for each of a plurality of source points in the binary map, a kernel including kernel points adjacent to the source point; and
detecting a touch group when a difference between a value of the source point and values of the kernel exists.
